(19) United States
(12) Patent Application Publication
(10) Pub. No.: US 2024/0092603 A1
(43) Pub. Date: Mar. 21, 2024

(54) MEDIUM PROCESSING SYSTEM

(71) Applicant: FUJIFILM Business Innovation Corp., Tokyo (JP)

(72) Inventors: Teisuke Yanagawa, Kanagawa (JP); Tomokazu Kurita, Kanagawa (JP); Raita Doi, Kanagawa (JP); Katsumi Tanaka, Kanagawa (JP)

(73) Assignee: FUJIFILM Business Innovation Corp., Tokyo (JP)

(21) Appl. No.: 18/178,896

(22) Filed: Mar. 6, 2023

(30) Foreign Application Priority Data
Sep. 15, 2022 (JP) 2022-147332
Sep. 15, 2022 (JP) 2022-147333

(51) Int. Cl. B65H 29/62

(52) U.S. Cl. CPC B65H 29/62

(57) ABSTRACT

A medium processing system includes: a pre-processing device; a first delivery device that receives a recording medium from the pre-processing device and that delivers the recording medium; a first post-processing device that receives the recording medium delivered from the first delivery device and that performs post-processing on the recording medium; one second delivery device or multiple second delivery devices that are connected in series with the first delivery device, that receive the recording medium delivered from an upstream side in a transport direction of the recording medium, and that deliver the recording medium; a second post-processing device that receives the recording medium delivered from the one second delivery device or the multiple second delivery devices and that performs post-processing on the recording medium; a first controller that is provided at the first delivery device and that communicates with the first post-processing device, the pre-processing device, and the second delivery device that receives the recording medium from the first delivery device, the first controller controlling the first delivery device and the first post-processing device; and a second controller that is provided at the one second delivery device or the multiple second delivery devices, that, for the second delivery device that receives the recording medium from the first delivery device, communicates with the second post-processing device and controls the second delivery device and the second post-processing device that receives the recording medium from the second delivery device, and that, for another one of the multiple second delivery devices that receives the recording medium delivered from the second delivery device, communicates with the second delivery device that delivers the recording medium and with the second post-processing device and controls the other one of the multiple second delivery devices and the second post-processing device that receives the recording medium from the other one of the multiple second delivery devices.

### CROSS-REFERENCE TO RELATED APPLICATIONS

This application is based on and claims priority under 35 USC 119 from Japanese Patent Application No. 2022-147332 filed Sep. 15, 2022 and Japanese Patent Application No. 2022-147333 filed Sep. 15, 2022.

### BACKGROUND

### (i) Technical Field

The present disclosure relates to a medium processing system.

### (ii) Related Art

Japanese Unexamined Patent Application Publication No. 2016-222461 describes a medium sheet router that receives a medium sheet, guides the medium sheet to a spiral path, and discharges the medium sheet.

### SUMMARY

In the related art, a medium processing system includes a pre-processing device, a first delivery device that receives a recording medium from the pre-processing device and delivers the recording medium, and a first post-processing device that receives the recording medium delivered from the first delivery device. In such a structure, one controller controls each of the first delivery device and the first post-processing device on the basis of a processing instruction of the pre-processing device.

For example, there may be a structure including a second delivery device that receives the recording medium delivered from the first delivery device and that is connected in series with the first delivery device, and a second post-processing device that receives the recording medium delivered from the second delivery device.

In such a structure, one controller controls each of the first delivery device, the second delivery device, the first post-processing device, and the second post-processing device. When the number of second delivery devices that are connected in series with the first delivery device increases, the number of post-processing devices that the controller controls is increased, as a result of which a control structure based on the controller changes considerably. That is, when the post-processing devices of the entire system are to be directly controlled by one controller, the control structure is to be changed due to the increase in the number of post-processing devices.

A first set of non-limiting embodiments of the present disclosure is to, when compared with directly controlling post-processing devices of an entire system by one controller, suppress a change in a control structure occurring due to an increase in the number of post-processing devices.

A medium processing system includes a pre-processing device, a delivery device that receives recording media from the pre-processing device and that delivers the recording media in multiple directions, and multiple post-processing devices that directly receive the recording media delivered from the delivery device.

In the related art, when, among the multiple post-processing devices, a malfunction occurs in one post-processing device, the entire medium processing system stops.

A second set of non-limiting embodiments of the present disclosure is to make it possible to, in a structure including multiple post-processing devices that directly receive recording media delivered from a delivery device, continuously process the media even if a malfunction occurs in one post-processing device.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a medium processing system including: a pre-processing device; a first delivery device that receives a recording medium from the pre-processing device and that delivers the recording medium; a first post-processing device that receives the recording medium delivered from the first delivery device and that performs post-processing on the recording medium; one second delivery device or multiple second delivery devices that are connected in series with the first delivery device, that receive the recording medium delivered from an upstream side in a transport direction of the recording medium, and that deliver the recording medium; a second post-processing device that receives the recording medium delivered from the one second delivery device or the multiple second delivery devices and that performs post-processing on the recording medium; a first controller that is provided at the first delivery device and that communicates with the first post-processing device, the pre-processing device, and the second delivery device that receives the recording medium from the first delivery device, the first controller controlling the first delivery device and the first post-processing device; and a second controller that is provided at the one second delivery device or the multiple second delivery devices, that, for the second delivery device that receives the recording medium from the first delivery device, communicates with the second post-processing device and controls the second delivery device and the second post-processing device that receives the recording medium from the second delivery device, and that, for another one of the multiple second delivery devices that receives the recording medium from the second delivery device, communicates with the second delivery device that delivers the recording medium and with the second post-processing device and controls the other one of the multiple second delivery devices and the second post-processing device that receives the recording medium from the other one of the multiple second delivery devices.

### BRIEF DESCRIPTION OF THE DRAWINGS

Exemplary embodiments of the present disclosure will be described in detail based on the following figures, wherein:

FIG. 1 is a plan view showing a medium processing system according to an exemplary embodiment of the present disclosure;

FIG. 2 is a schematic structural view showing an image forming apparatus of the medium processing system according to the exemplary embodiment of the present disclosure;

FIG. 3 is a perspective view showing an intermediate transport device of the medium processing system according to the exemplary embodiment of the present disclosure;

FIGS. 4A and 4B are, respectively, a side sectional view and a plan sectional view showing the intermediate transport device of the medium processing system according to the exemplary embodiment of the present disclosure;

FIGS. 5A and 5B are, respectively, a block diagram of a hardware configuration and a block diagram of a functional configuration of a controlling device of the intermediate transport device of the medium processing system according to the exemplary embodiment of the present disclosure;

FIG. 6 is a schematic structural view showing a folding device of the medium processing system according to the exemplary embodiment of the present disclosure;

FIG. 7 is a schematic structural view showing a cutting device of the medium processing system according to the exemplary embodiment of the present disclosure;

FIG. 8 is a perspective view showing an intermediate transport device of the medium processing system according the exemplary embodiment of the present disclosure;

FIGS. 9A and 9B are, respectively, a side sectional view and a plan sectional view showing the intermediate transport device of the medium processing system according to the exemplary embodiment of the present disclosure;

FIGS. 10A and 10B are, respectively, a block diagram of a hardware configuration and a block diagram of a functional configuration of a controlling device of the intermediate transport device of the medium processing system according to the exemplary embodiment of the present disclosure;

FIG. 11 is a perspective view showing an intermediate transport device of the medium processing system according the exemplary embodiment of the present disclosure;

FIGS. 12A and 12B are, respectively, a side sectional view and a plan sectional view showing the intermediate transport device of the medium processing system according to the exemplary embodiment of the present disclosure;

FIGS. 13A and 13B are, respectively, a block diagram of a hardware configuration and block diagram of a functional configuration of a controlling device of the intermediate transport device of the medium processing system according to the exemplary embodiment of the present disclosure;

FIG. 14 is a schematic structural view showing a folding device of the medium processing system according to the exemplary embodiment of the present disclosure;

FIGS. 15A and 15B are each a flow diagram showing the flow of operation steps performed by the medium processing system according to the exemplary embodiment of the present disclosure;

FIGS. 16A and 16B are operation views showing operations of each intermediate transport device of the medium processing system according to the exemplary embodiment of the present disclosure;

FIGS. 17A and 17B are operation views showing operations of each intermediate transport device of the medium processing system according to the exemplary embodiment of the present disclosure;

FIG. 18 is a block diagram showing the flow of operation steps performed by the medium processing system according to the exemplary embodiment of the present disclosure;

FIG. 19 is a block diagram showing the flow of operation steps performed by the medium processing system according to the exemplary embodiment of the present disclosure;

FIGS. 20A and 20B are operation views showing operations of each intermediate transport device of the medium processing system according to the exemplary embodiment of the present disclosure;

FIG. 21 is a flow diagram showing the flow of operation steps performed by the medium processing system according to the exemplary embodiment of the present disclosure; and

FIG. 22 is a flow diagram showing the flow of operation steps performed by the medium processing system according to the exemplary embodiment of the present disclosure.

### DETAILED DESCRIPTION

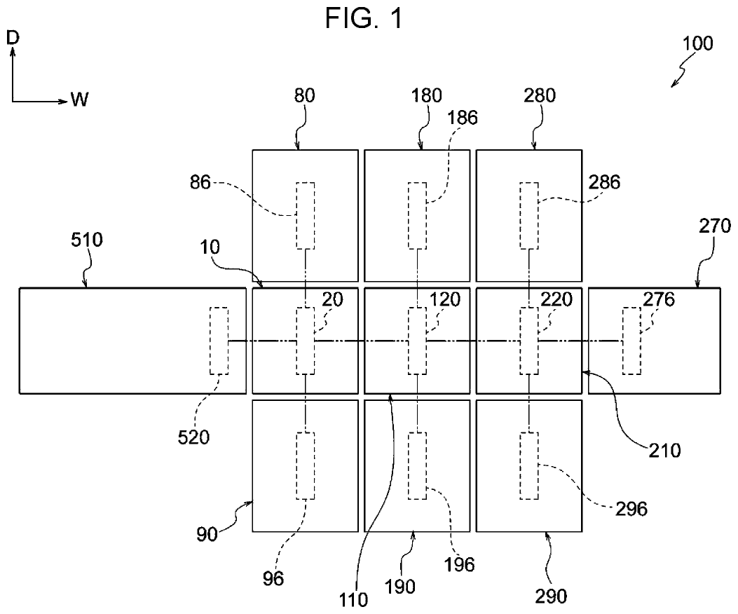

An example of a medium processing system according to an exemplary embodiment of the present disclosure is described in accordance with FIGS. 1 to 22. Note that an arrow H in each figure indicates an up-down direction, which is a vertical direction; an arrow W indicates a width direction, which is a horizontal direction; and an arrow D indicates a depth direction, which is a horizontal direction. The arrow H, the arrow W, and the arrow D are orthogonal to each other.

As shown in FIG. 1, a medium processing system 100 includes, from an upstream side in a transport direction of a sheet member P serving as a recording medium, an image forming apparatus 510, an intermediate transport device 10, an intermediate transport device 110, and an intermediate transport device 210.

Further, the medium processing system 100 includes a folding device 80 and a cutting device 90 that receive a sheet member P from the intermediate transport device 10; a folding device 180 and a cutting device 190 that receive a sheet member P from the intermediate transport device 110; and a folding device 270, a folding device 280, and a cutting device 290 that receive a sheet member P from the intermediate transport device 210.

The image forming apparatus 510 is an example of a pre-processing device, the intermediate transport device 10 is an example of a first delivery device, the folding device 80 and the cutting device 90 are each an example of a first post-processing device, and the intermediate transport device 110 and the intermediate transport device 210 are each an example of a second delivery device. The folding device 180, the cutting device 190, the folding device 270, the folding device 280, and the cutting device 290 are each an example of a second post-processing device.

The intermediate transport device 10 is disposed on one side in the width direction with respect to the image forming apparatus 510, and is connected to the image forming apparatus 510 by a connection member (not shown). The folding device 80 is disposed on a far side in the depth direction with respect to the intermediate transport device 10, and is connected to the intermediate transport device 10 by a connection member (not shown). The cutting device 90 is disposed on a near side in the depth direction with respect to the intermediate transport device 10, and is connected to the intermediate transport device 10 by a connection member (not shown).

The intermediate transport device 110 is disposed on one side in the width direction with respect to the intermediate transport device 10, and is connected to the intermediate transport device 10 by a connection member (not shown). The folding device 180 is disposed on a far side in the depth direction with respect to the intermediate transport device 110, and is connected to the intermediate transport device 110 by a connection member (not shown). The cutting device 190 is disposed on a near side in the depth direction with respect to the intermediate transport device 110, and is connected to the intermediate transport device 110 by a connection member (not shown).

The intermediate transport device 210 is disposed on one side in the width direction with respect to the intermediate transport device 110, and is connected to the intermediate transport device 110 by a connection member (not shown). The folding device 270 is disposed on one side in the width direction with respect to the intermediate transport device 210, and is connected to the intermediate transport device 210 by a connection member (not shown). The folding device 280 is disposed on a far side in the depth direction with respect to the intermediate transport device 210, and is connected to the intermediate transport device 210 by a connection member (not shown). The cutting device 290 is disposed on a near side in the depth direction with respect to the intermediate transport device 210, and is connected to the intermediate transport device 210 by a connection member (not shown).

As described above, the intermediate transport device 110 and the intermediate transport device 210 are connected in series with the intermediate transport device 10. In other words, the intermediate transport device 110 and the intermediate transport device 210 are linked in series with the intermediate transport device 10.

### Image Forming Apparatus 510

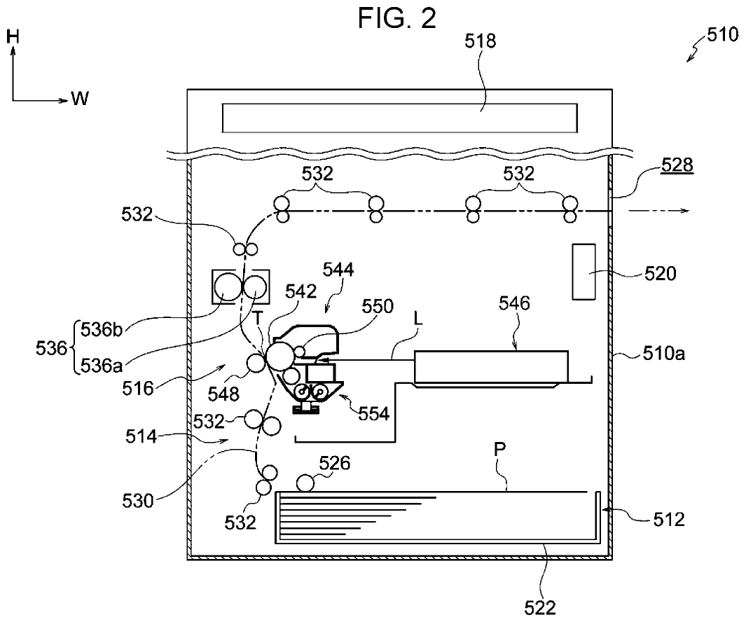

As shown in FIG. 2, the image forming apparatus 510 includes a sheet storage unit 512 that stores sheet members P as recording media, a transport unit 514 that transports the sheet members P, and an image forming device 516 that forms images on the sheet members P that are transported. The image forming apparatus 510 further includes an operation screen 518 that is to be operated by a user, and a controller 520 that controls each portion.

### Sheet Storage Unit 512

As shown in FIG. 2, the sheet storage unit 512 includes a storage member 522 that is capable of storing sheet members P, and a delivery roller 526 that delivers the sheet members P stored in the storage member 522 to a transport path 530 of the sheet members P.

### Transport Unit 514

As shown in FIG. 2, the transport unit 514 includes multiple transport rollers 532 that transport along the transport path 530 sheet members P that have been delivered to the transport path 530 from the storage member 522. In addition, sheet members P on which images are formed are delivered to the outside from a delivery port 528 formed in a housing 510a of the image forming apparatus 510.

### Image Forming Device 516

As shown in FIG. 2, the image forming device 516 includes an image forming unit 544, an exposure device 546 that forms an electrostatic latent image by irradiating an image carrier 542 of the image forming unit 544 with exposure light L, and a transfer roller 548 that transfers to a sheet member P a toner image formed by the image forming unit 544. The image forming device 516 further includes a fixing device 536 that fixes to the sheet member P the toner image transferred to the sheet member P.

The image forming unit 544 includes a charger 550 that charges an outer peripheral surface of the image carrier 542 that rotates, and a developing device 554 that develops into a toner image the electrostatic latent image formed on the image carrier 542 by the exposure device 546. The transfer roller 548 is disposed on a side opposite to the image carrier 542 with the transport path 530 therebetween.

As shown in FIG. 2, the fixing device 536 is disposed downstream of the transfer roller 548 in the transport direction of a sheet member P, and includes a heating roller 536a and a pressure roller 536b. Therefore, as a result of transporting a sheet member P while nipping the sheet member P between the heating roller 536a and the pressure roller 536b, a toner image transferred to the sheet member P is fixed to the sheet member P by heat and pressure.

### Operation Screen 518

The operation screen 518 is a so-called user interface, and is a screen where a user using the image forming apparatus 510 transfers information between the user and the image forming apparatus 510. Specifically, the operation screen 518 is a screen where the user instructs the image forming apparatus 510 to, for example, perform an image formation operation, and where the user is informed about an operation state of the image forming apparatus 510.

### Controller 520

The controller 520 controls each portion on the basis of a processing instruction issued by a user. Here, a processing instruction is a unit of processing of a processing operation executed due to one instruction issued by the user. The controller 520 is an example of a pre-processing controller.

In the structure above, the charger 550 charges the surface of the image carrier 542. Then, on the basis of image data, the exposure device 546 irradiates the charged surface of the image carrier 542 with exposure light to form an electrostatic latent image. The electrostatic latent image is developed by the developing device 554 to make visible the electrostatic latent image as a toner image.

Here, a sheet member P that has been delivered to the transport path 530 by the delivery roller 526 from the storage member 522 is delivered to a transfer position T where the transfer roller 548 and the image carrier 542 contact each other. At the transfer position T, as a result of nipping and transporting the sheet member P by the image carrier 542 and the transfer roller 548, the toner image formed on the surface of the image carrier 542 is transferred to a surface of the sheet member P.

The toner image transferred to the sheet member P is fixed to the sheet member P as a result of the sheet member P passing between the heating roller 536a and the pressure roller 536b of the fixing device 536. Then, the sheet member P to whose surface the toner image has been fixed is delivered to the outside from the delivery port 528 by the transport rollers 532.

### Intermediate Transport Device 10

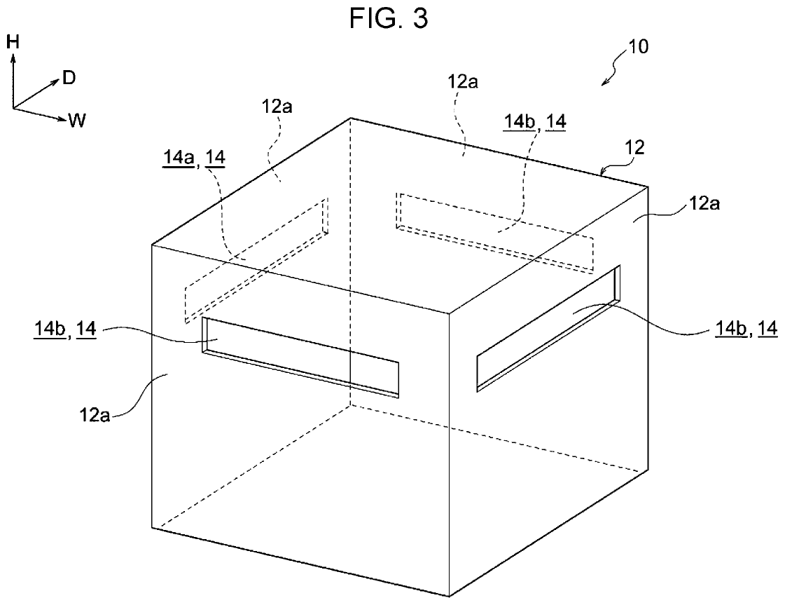

As shown in FIG. 3, the intermediate transport device 10 has a parallelepiped housing 12 having a square shape in plan view, and an opening 14 is formed in each of four side walls 12a of the housing 12. In the exemplary embodiment, the opening 14 formed in the side wall 12a facing another side in the width direction is a reception port 14a that receives a sheet member P. On the other hand, the opening 14 formed in the side wall 12a facing a far side in the depth direction, the opening 14 formed in the side wall 12a facing one side in the width direction, and the opening 14 formed in the side wall 12a facing a near side in the depth direction are delivery ports 14b that deliver sheet members P. The intermediate transport device 10 is an example of a first delivery device.

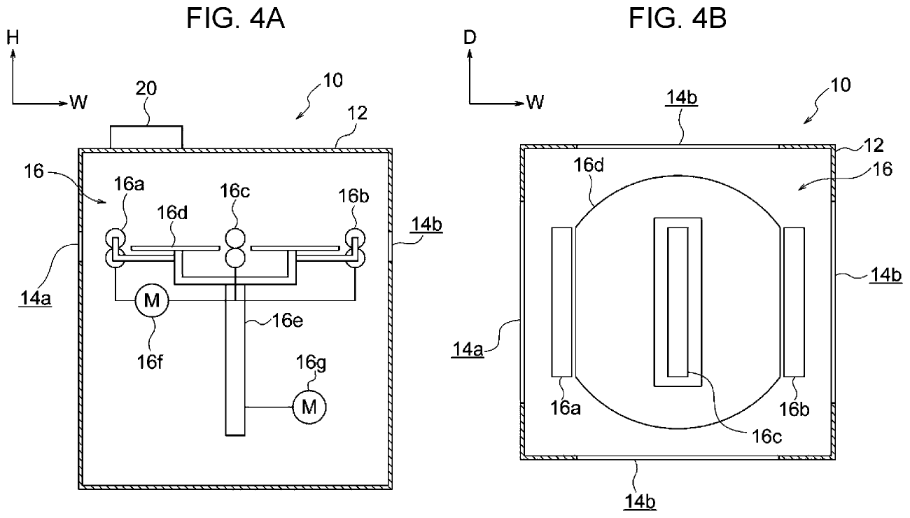

As shown in FIGS. 4A and 4B, the intermediate transport device 10 includes a changing unit 16 that is capable of changing a delivery direction of a sheet member P, and a controlling device 20 that is capable of being attached to and detached from the housing 12. The controlling device 20 is an example of a first controller.

### Changing Unit 16

The changing unit 16 includes a reception roller 16a that receives a sheet member P through the reception port 14a, a delivery roller 16b that delivers a sheet member P to the outside through one of the delivery ports 14b, and an intermediate roller 16c that is disposed between the reception roller 16a and the delivery roller 16b. These rollers are such that a rotational force is transmitted thereto through a transmission member (not shown) from a driving unit 16f. Note that, for example, a servomotor that is capable of controlling a rotation position and the number of rotations is used for the driving unit 16f.

The changing unit 16 further includes a plate-shaped reception table 16d on which a received sheet member P is to be placed. As seen from above, the reception table 16d has a circular shape in which portions where the reception roller 16a and the delivery roller 16b are disposed are cut off, and is disposed between the reception roller 16a and the delivery roller 16b. A central portion of the reception table 16d has a through hole in which the intermediate roller 16c is disposed.

The reception roller 16a, the delivery roller 16b, the intermediate roller 16c, and the reception table 16d are connected to each other through, for example, a bracket (not shown).

The changing unit 16 further includes a shaft portion 16e and a driving unit 16g that rotates the shaft portion 16e, the shaft portion 16e becoming a rotational shaft that supports the reception table 16d and rotates, for example, the reception table 16d. An axial direction of the shaft portion 16e is an up-down direction (vertical direction), and an upper portion of the shaft portion 16e is divided in a horizontal direction, and the separated upper end portions are in contact with a back surface of the reception table 16d. The reception roller 16a, the delivery roller 16b, the intermediate roller 16c, and the reception table 16d rotate together around the center of the circular reception table 16d as a rotation center as a result of the driving unit 16g rotating the shaft portion 16e. Note that, for example, a servomotor that is capable of controlling a rotation position and the number of rotations is used for the driving unit 16g.

### Controlling Device 20

As shown in FIG. 1, the controlling device 20 communicates with a controlling device 120 of the intermediate transport device 110, a controller 86 of the folding device 80, a controller 96 of the cutting device 90, and the controller 520 of the image forming apparatus 510. On the basis of a processing instruction that is received from the controller 520 of the image forming apparatus 510, the controlling device 20 controls the folding device 80 and the cutting device 90.

### Hardware Configuration of Controlling Device 20

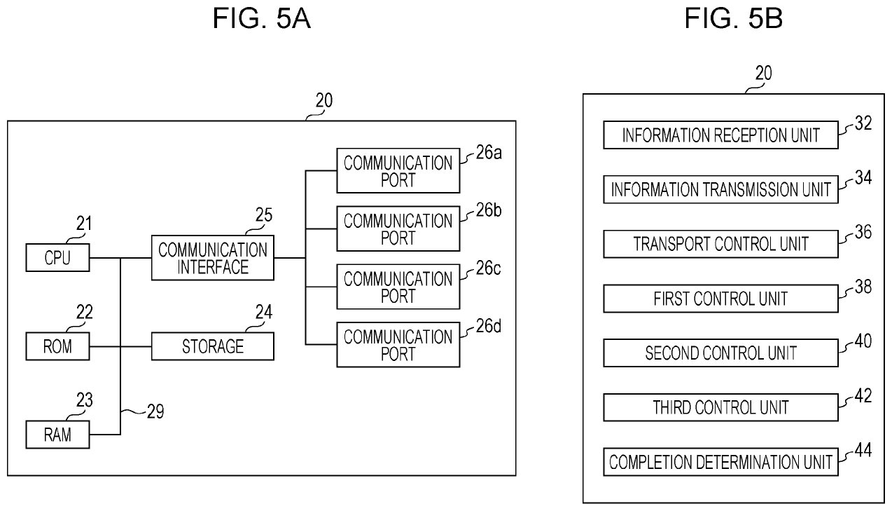

As shown in FIG. 5A, the controlling device 20 has a central processing unit (CPU) 21, a read only memory (ROM) 22, a random access memory (RAM) 23, a storage 24, and a communication interface (UF) 25. Each structure is connected so that communication is possible therebetween through a bus 29.

The CPU 21 is a central processing unit, and executes various programs and controls each portion. That is, the CPU 21 reads a program from ROM 22 or the storage 24, and executes the program with RAM 23 as a work space. The CPU 21 controls each structure and performs various arithmetic processing operations in accordance with the program recorded in ROM 22 or the storage 24. In the exemplary embodiment, ROM 22 or the storage 24 stores, for example, a control program that controls the changing unit 16, the folding device 80, and the cutting device 90 by receiving a processing instruction from the controller 520 of the image forming apparatus 510.

ROM 22 stores various programs and various pieces of data. As a work space, RAM 23 temporarily stores a program or data. The storage 24 is constituted by a hard disk drive (HDD) or a solid state drive (SSD), and stores various programs including operating systems, and various pieces of data.

The communication interface 25 is an interface for allowing the controlling device 20 to communicate with the image forming apparatus 510, the intermediate transport device 110, the folding device 80, and the cutting device 90, with, for example, Ethernet (registered trademark) standards, FDDI standards, or Wi-Fi (registered trademark) standards being used. The communication interface 25 has a communication port 26a for communication with the image forming apparatus 510, a communication port 26b for communication with the intermediate transport device 110, a communication port 26c for communication with the folding device 80, and a communication port 26d for communication with the cutting device 90.

That is, the controlling device 20 is provided with communication ports in accordance with the number of receiving devices that receive a sheet member P from the intermediate transport device 10 and the number of delivery devices that deliver a sheet member P to the intermediate transport device 10. In other words, the controlling device 20 is not provided with communication ports for communication with devices other than receiving devices that receive a sheet member P from the intermediate transport device 10 or delivery devices that deliver a sheet member P to the intermediate transport device 10.

When any processing program above is to be executed, the controlling device 20 realizes various functions by using any of the hardware resources above. A functional configuration that the controlling device 20 realizes is described.

### Functional Configuration of Controlling Device 20

As shown in FIG. 5B, the controlling device 20 has an information reception unit 32, an information transmission unit 34, a transport control unit 36, a first control unit 38, a second control unit 40, a third control unit 42, and a completion determination unit 44. Each functional structure is realized as a result of the CPU 21 reading and executing a processing program stored in ROM 22 or the storage 24.

The information reception unit 32 receives a processing instruction with respect to a sheet member P from the image forming apparatus 510. The information transmission unit 34 transmits a processing state with respect to the sheet member P to the controller 520 of the image forming apparatus 510.

Further, on the basis of a processing instruction, the transport control unit 36 controls, for example, the changing unit 16 of the intermediate transport device 10. On the basis of a processing instruction, the first control unit 38 transfers information between it and the controlling device 120 of the intermediate transport device 110. On the basis of a processing instruction, the second control unit 40 transfers information between it and the controller 86 of the folding device 80. On the basis of a processing instruction, the third control unit 42 transfers information between it and the controller 96 of the cutting device 90. The completion determination unit 44 determines whether or not the processing instructions have been completed.

### Folding Device 80

The folding device 80 is a known folding device, and receives a sheet member P and performs a determined folding operation on the received sheet member P.

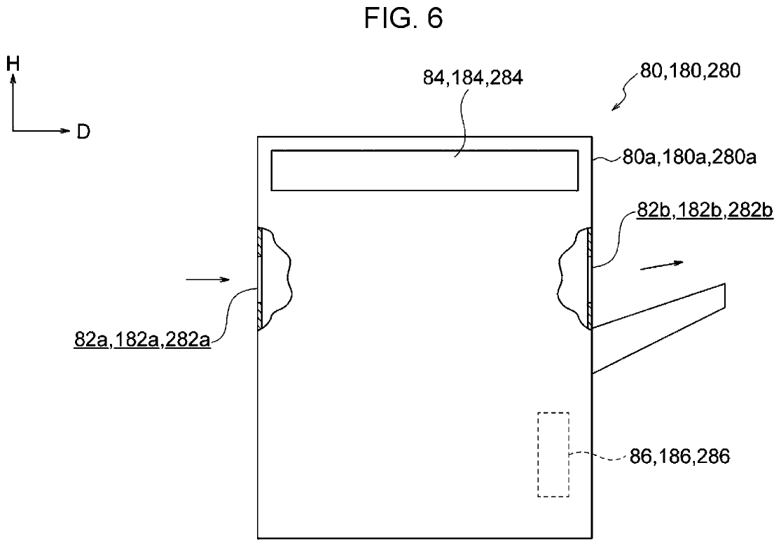

As shown in FIG. 6, the folding device 80 includes the controller 86 that controls each portion of the folding device 80, and a housing 80a of the folding device 80 has a reception port 82a that receives a sheet member P and a delivery port 82b that delivers the sheet member P that has been subjected to a folding operation. Specifically, as seen from a side of an operation screen 84 of the folding device 80, the reception port 82a is formed on a near side in the depth direction, and the delivery port 82b is formed on a far side in the depth direction.

In this structure, the folding device 80 receives a sheet member P from the near side in the depth direction, and delivers the sheet member P that has been subjected to a folding operation to the far side in the depth direction. The far side in the depth direction is an example of a second direction.

### Cutting Device 90

The cutting device 90 is a known cutting device, and receives a sheet member P and performs a determined cutting operation on the received sheet member P.

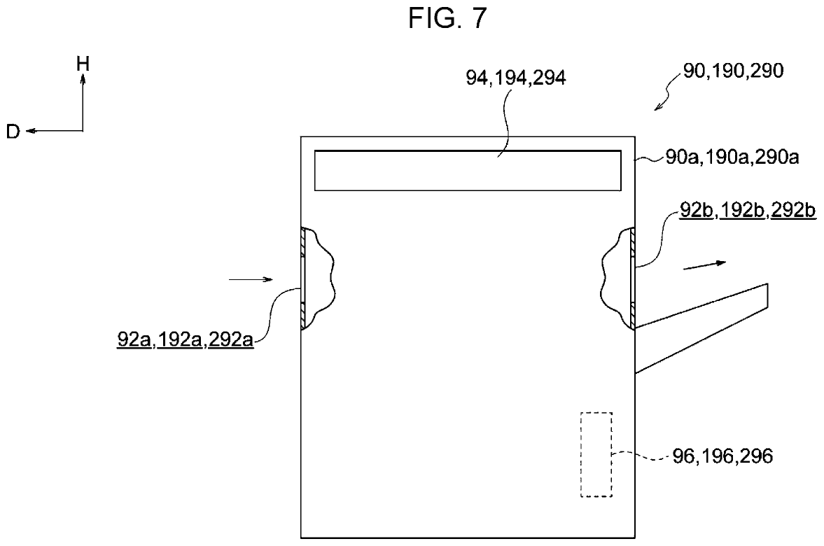

As shown in FIG. 7, the cutting device 90 includes the controller 96 that controls each portion of the cutting device 90, and a housing 90a of the cutting device 90 has a reception port 92a that receives a sheet member P and a delivery port 92b that delivers the sheet member P that has been subjected to a cutting operation. Specifically, as seen from a side of an operation screen 94 of the cutting device 90, the reception port 92a is formed on a far side in the depth direction, and the delivery port 92b is formed on a near side in the depth direction.

In this structure, the cutting device 90 receives a sheet member P from the far side in the depth direction and delivers the sheet member P that has been subjected to a cutting operation to the near side in the depth direction. The near side in the depth direction is an example of a first direction.

### Intermediate Transport Device 110

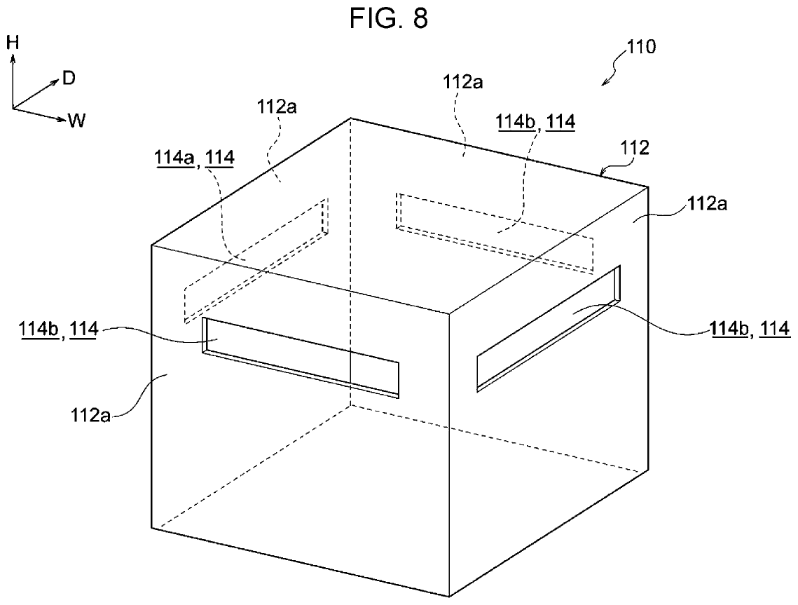

As shown in FIG. 8, the intermediate transport device 110 has a parallelepiped housing 112 having a square shape in plan view, and an opening 114 is formed in each of four side walls 112a of the housing 112. In the exemplary embodiment, the opening 114 formed in the side wall 112a facing another side in the width direction is a reception port 114a that receives a sheet member P. On the other hand, the opening 114 formed in the side wall 112a facing a far side in the depth direction, the opening 114 formed in the side wall 112a facing one side in the width direction, and the opening 114 formed in the side wall 112a facing a near side in the depth direction are delivery ports 114b that deliver sheet members P. The intermediate transport device 110 is an example of a second delivery device.

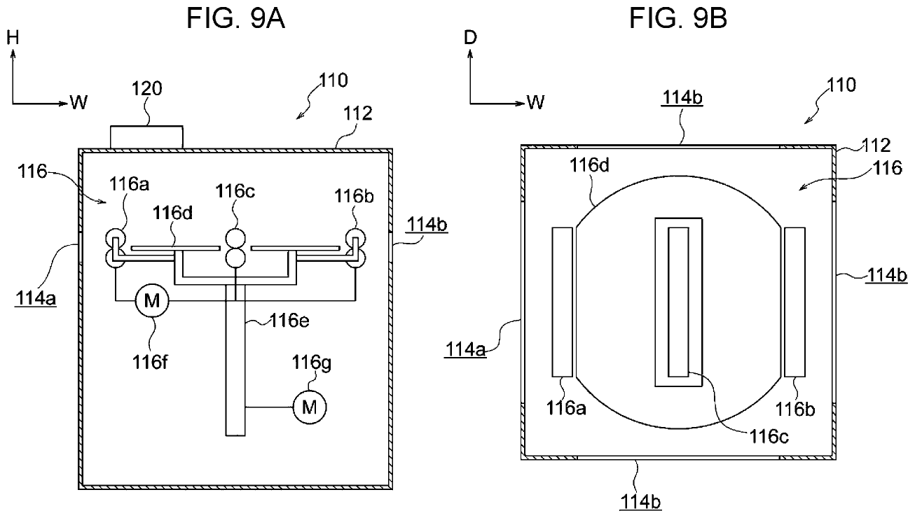

As shown in FIGS. 9A and 9B, the intermediate transport device 110 includes a changing unit 116 that is capable of changing a delivery direction of a sheet member P, and a controlling device 120 that is capable of being attached to and detached from the housing 112. The controlling device 120 is an example of a second controller.

### Changing Unit 116

The changing unit 116 includes a reception roller 116a that receives a sheet member P through the reception port 114a, a delivery roller 116b that delivers a sheet member P to the outside through one of the delivery ports 114b, and an intermediate roller 116c that is disposed between the reception roller 116a and the delivery roller 116b. These rollers are such that a rotational force is transmitted thereto through a transmission member (not shown) from a driving unit 116f. Note that, for example, a servomotor that is capable of controlling a rotation position and the number of rotations is used for the driving unit 116f.

The changing unit 116 further includes a plate-shaped reception table 116d on which a received sheet member P is to be placed. As seen from above, the reception table 116d has a circular shape in which portions where the reception roller 116a and the delivery roller 116b are disposed are cut off, and is disposed between the reception roller 116a and the delivery roller 116b. A central portion of the reception table 116d has a through hole in which the intermediate roller 116c is disposed. The reception roller 116a, the delivery roller 116b, the intermediate roller 116c, and the reception table 116d are connected to each other through, for example, a bracket (not shown).

The changing unit 116 further includes a shaft portion 116e and a driving unit 116g that rotates the shaft portion 116e, the shaft portion 116e becoming a rotational shaft that supports the reception table 116d and rotates, for example, the reception table 116d. An axial direction of the shaft portion 116e is an up-down direction (vertical direction), and an upper portion of the shaft portion 116e is divided in a horizontal direction, and the separated upper end portions are in contact with a back surface of the reception table 116d. The reception roller 116a, the delivery roller 116b, the intermediate roller 116c, and the reception table 116d rotate together around the center of the circular reception table 116d as a rotation center as a result of the driving unit 116g rotating the shaft portion 116e. Note that, for example, a servomotor that is capable of controlling a rotation position and the number of rotations is used for the driving unit 116g.

### Controlling Device 120

As shown in FIG. 1, the controlling device 120 communicates with a controlling device 220 of the intermediate transport device 210, the controller 186 of the folding device 180, a controller 196 of the cutting device 190, and the controlling device 20 of the intermediate transport device 10. On the basis of an instruction from the controlling device 20 of the intermediate transport device 10, the controlling device 120 controls the folding device 180 and the cutting device 190.

### Hardware Configuration of Controlling Device 120

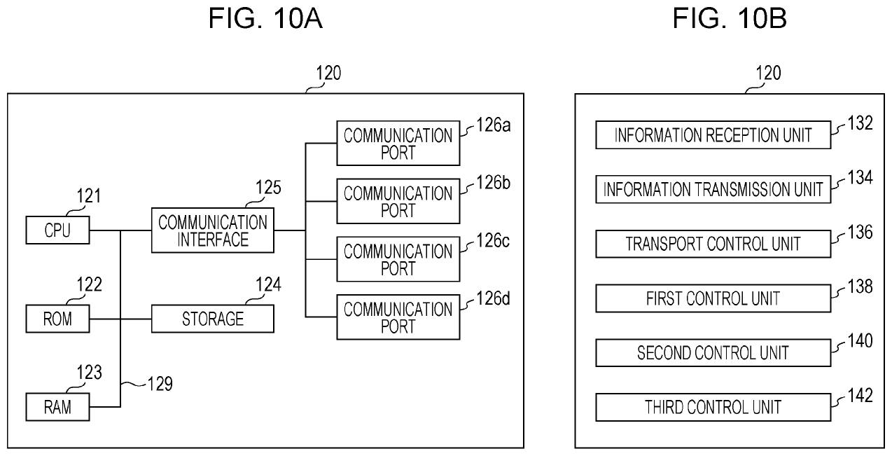

As shown in FIG. 10A, the controlling device 120 has a central processing unit (CPU) 121, a read only memory (ROM) 122, a random access memory (RAM) 123, a storage 124, and a communication interface (UF) 125. Each structure is connected so that communication is possible therebetween through a bus 129.

The CPU 121 is a central processing unit, and executes various programs and controls each portion. That is, the CPU 121 reads a program from ROM 122 or the storage 124, and executes the program with RAM 123 as a work space. The CPU 121 controls each structure and performs various arithmetic processing operations in accordance with the program recorded in ROM 122 or the storage 124. In the exemplary embodiment, ROM 122 or the storage 124 stores, for example, a control program that controls the changing unit 116, the folding device 180, and the cutting device 190 by receiving an instruction from the controlling device 20 of the intermediate transport device 10.

ROM 122 stores various programs and various pieces of data. As a work space, RAM 123 temporarily stores a program or data. The storage 124 is constituted by a hard disk drive (HDD) or a solid state drive (SSD), and stores various programs including operating systems, and various pieces of data.

The communication interface 125 is an interface for allowing the controlling device 120 to communicate with the intermediate transport device 10, the intermediate transport device 210, the folding device 180, and the cutting device 190, with, for example, Ethernet (registered trademark) standards, FDDI standards, or Wi-Fi (registered trademark) standards being used. The communication interface 125 has a communication port 126a for communication with the intermediate transport device 10, a communication port 126b for communication with the intermediate transport device 210, a communication port 126c for communication with the folding device 180, and a communication port 126d for communication with the cutting device 190.

That is, the controlling device 120 is provided with communication ports in accordance with the number of receiving devices that receive a sheet member P from the intermediate transport device 110 and the number of delivery devices that deliver a sheet member P to the intermediate transport device 110. In other words, the controlling device 120 is not provided with communication ports for communication with devices other than receiving devices that receive a sheet member P from the intermediate transport device 110 or delivery devices that deliver a sheet member P to the intermediate transport device 110.

When any processing program above is to be executed, the controlling device 120 realizes various functions by using any of the hardware resources above. A functional configuration that the controlling device 120 realizes is described.

### Functional Configuration of Controlling Device 120

As shown in FIG. 10B, the controlling device 120 has an information reception unit 132, an information transmission unit 134, a transport control unit 136, a first control unit 138, a second control unit 140, and a third control unit 142. Each functional structure is realized as a result of the CPU 121 reading and executing a processing program stored in ROM 122 or the storage 124.

The information reception unit 132 receives an instruction from the controlling device 20 of the intermediate transport device 10. The information transmission unit 134 transmits a processing state with respect to a sheet member P to the controlling device 20 of the intermediate transport device 10.

Further, on the basis of a processing instruction, the transport control unit 136 controls, for example, the changing unit 116 of the intermediate transport device 110. On the basis of a processing instruction, the first control unit 138 transfers information between it and the controlling device 220 of the intermediate transport device 210. On the basis of a processing instruction, the second control unit 140 transfers information between it and the controller 186 of the folding device 180. On the basis of a processing instruction, the third control unit 142 transfers information between it and the controller 196 of the cutting device 190.

### Folding Device 180

The folding device 180 is a known folding device, and receives a sheet member P and performs a determined folding operation on the received sheet member P.

As shown in FIG. 6, the folding device 180 includes the controller 186 that controls each portion of the folding device 180, and a housing 180a of the folding device 180 has a reception port 182a that receives a sheet member P and a delivery port 182b that delivers the sheet member P that has been subjected to a folding operation. Specifically, as seen from a side of an operation screen 184 of the folding device 180, the reception port 182a is formed on a near side in the depth direction, and the delivery port 182b is formed on a far side in the depth direction.

In this structure, the folding device 180 receives a sheet member P from the near side in the depth direction, and delivers the sheet member P that has been subjected to a folding operation to the far side in the depth direction.

### Cutting Device 190

The cutting device 190 is a known cutting device, and receives a sheet member P and performs a determined cutting operation on the received sheet member P.

As shown in FIG. 7, the cutting device 190 includes the controller 196 that controls each portion of the cutting device 190, and a housing 190a of the cutting device 190 has a reception port 192a that receives a sheet member P and a delivery port 192b that delivers the sheet member P that has been subjected to a cutting operation. Specifically, as seen from a side of an operation screen 194 of the cutting device 190, the reception port 192a is formed on a far side in the depth direction, and the delivery port 192b is formed on a near side in the depth direction.

In this structure, the cutting device 190 receives a sheet member P from the far side in the depth direction and delivers the sheet member P that has been subjected to a cutting operation to the near side in the depth direction.

### Intermediate Transport Device 210

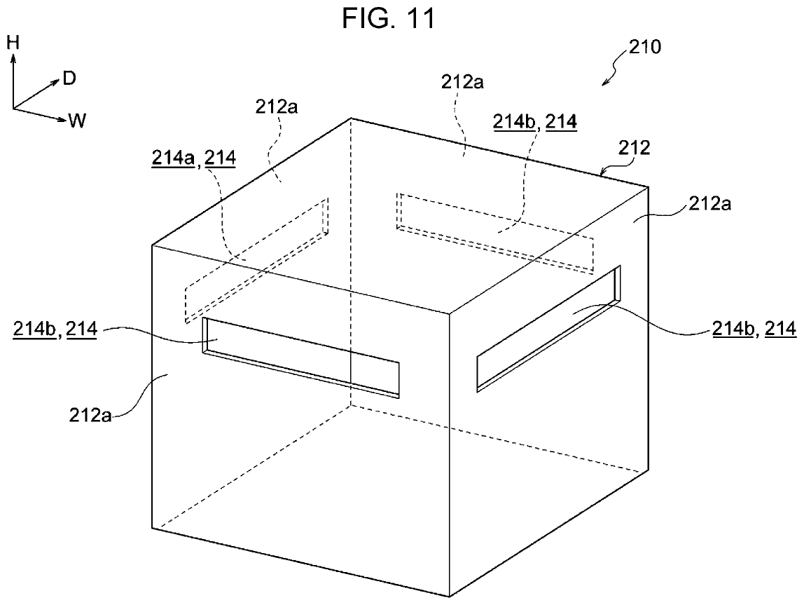

As shown in FIG. 11, the intermediate transport device 210 has a parallelepiped housing 212 having a square shape in plan view, and an opening 214 is formed in each of four side walls 212a of the housing 212. In the exemplary embodiment, the opening 214 formed in the side wall 212a facing another side in the width direction is a reception port 214a that receives a sheet member P. On the other hand, the opening 214 formed in the side wall 212a facing a far side in the depth direction, the opening 214 formed in the side wall 212a facing one side in the width direction, and the opening 214 formed in the side wall 212a facing a near side in the depth direction are delivery ports 214b that deliver sheet members P. The intermediate transport device 210 is an example of a second delivery device.

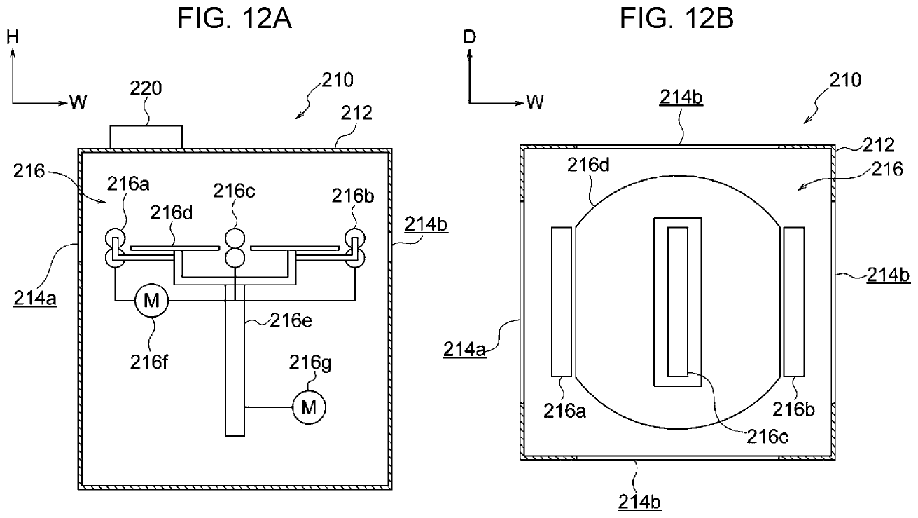

As shown in FIGS. 12A and 12B, the intermediate transport device 210 includes a changing unit 216 that is capable of changing a delivery direction of a sheet member P, and a controlling device 220 that is capable of being attached to and detached from the housing 212. The controlling device 220 is an example of a second controller.

### Changing Unit 216

The changing unit 216 includes a reception roller 216a that receives a sheet member P through the reception port 214a, a delivery roller 216b that delivers a sheet member P to the outside through one of the delivery ports 214b, and an intermediate roller 216c that is disposed between the reception roller 216a and the delivery roller 216b. These rollers are such that a rotational force is transmitted thereto through a transmission member (not shown) from a driving unit 216f. Note that, for example, a servomotor that is capable of controlling a rotation position and the number of rotations is used for the driving unit 216f.

The changing unit 216 further includes a plate-shaped reception table 216d on which a received sheet member P is to be placed. As seen from above, the reception table 216d has a circular shape in which portions where the reception roller 216a and the delivery roller 216b are disposed are cut off, and is disposed between the reception roller 216a and the delivery roller 216b. A central portion of the reception table 216d has a through hole in which the intermediate roller 216c is disposed. The reception roller 216a, the delivery roller 216b, the intermediate roller 216c, and the reception table 216d are connected to each other through, for example, a bracket (not shown).

The changing unit 216 further includes a shaft portion 216e and a driving unit 216g that rotates the shaft portion 216e, the shaft portion 216e becoming a rotational shaft that supports the reception table 216d and rotates, for example, the reception table 216d. An axial direction of the shaft portion 216e is an up-down direction (vertical direction), and an upper portion of the shaft portion 216e is divided in a horizontal direction, and the separated upper end portions are in contact with a back surface of the reception table 216d. The reception roller 216a, the delivery roller 216b, the intermediate roller 216c, and the reception table 216d rotate together around the center of the circular reception table 216d as a rotation center as a result of the driving unit 216g rotating the shaft portion 216e. Note that, for example, a servomotor that is capable of controlling a rotation position and the number of rotations is used for the driving unit 216g.

### Controlling Device 220

As shown in FIG. 1, the controlling device 220 communicates with a controller 276 of the folding device 270, a controller 286 of the folding device 280, a controller 296 of the cutting device 290, and the controlling device 120 of the intermediate transport device 110. On the basis of an instruction from the controlling device 20 of the intermediate transport device 10 that is transmitted through the controlling device 120, the controlling device 220 controls the changing unit 216, the folding device 270, the folding device 280, and the cutting device 290.

### Hardware Configuration of Controlling Device 220

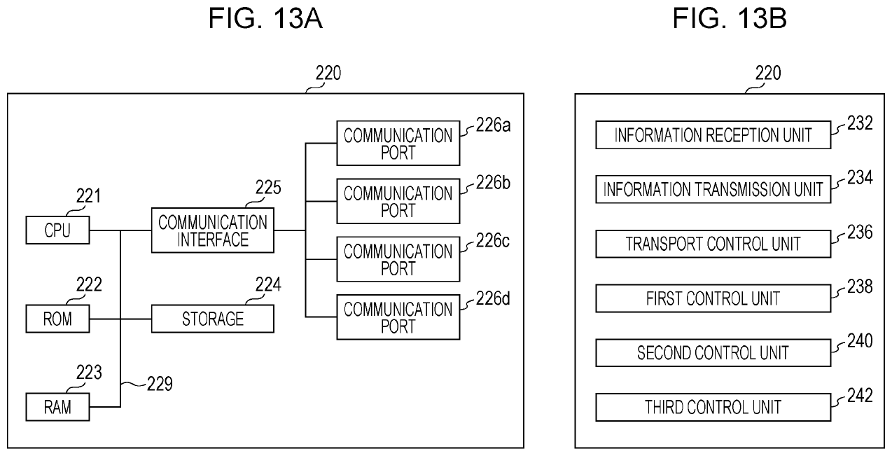

As shown in FIG. 13A, the controlling device 220 has a central processing unit (CPU) 221, a read only memory (ROM) 222, a random access memory (RAM) 223, a storage 224, and a communication interface (UF) 225. Each structure is connected so that communication is possible therebetween through a bus 229.

The CPU 221 is a central processing unit, and executes various programs and controls each portion. That is, the CPU 221 reads a program from ROM 222 or the storage 224, and executes the program with RAM 223 as a work space. The CPU 221 controls each structure and performs various arithmetic processing operations in accordance with the program recorded in ROM 222 or the storage 224. In the exemplary embodiment, ROM 222 or the storage 224 stores, for example, a control program that controls the changing unit 216, the folding device 270, the folding device 280, and the cutting device 290 by receiving an instruction from the controlling device 20 of the intermediate transport device 10 through the controlling device 120.

ROM 222 stores various programs and various pieces of data. As a work space, RAM 223 temporarily stores a program or data. The storage 224 is constituted by a hard disk drive (HDD) or a solid state drive (SSD), and stores various programs including operating systems, and various pieces of data.

The communication interface 225 is an interface for allowing the controlling device 220 to communicate with the intermediate transport device 110, the folding device 270, the folding device 280, and the cutting device 290, with, for example, Ethernet (registered trademark) standards, FDDI standards, or Wi-Fi (registered trademark) standards being used. The communication interface 225 has a communication port 226a for communication with the intermediate transport device 110, a communication port 226b for communication with the folding device 270, a communication port 226c for communication with the folding device 280, and a communication port 226d for communication with the cutting device 290.

That is, the controlling device 220 is provided with communication ports in accordance with the number of receiving devices that receive a sheet member P from the intermediate transport device 210 and the number of delivery devices that deliver a sheet member P to the intermediate transport device 210. In other words, the controlling device 220 is not provided with communication ports for communication with devices other than receiving devices that receive a sheet member P from the intermediate transport device 210 or delivery devices that deliver a sheet member P to the intermediate transport device 210.

When any processing program above is to be executed, the controlling device 220 realizes various functions by using any of the hardware resources above. A functional configuration that the controlling device 220 realizes is described.

### Functional Configuration of Controlling Device 220

As shown in FIG. 13B, the controlling device 220 has an information reception unit 232, an information transmission unit 234, a transport control unit 236, a first control unit 238, a second control unit 240, and a third control unit 242. Each functional structure is realized as a result of the CPU 221 reading and executing a processing program stored in ROM 222 or the storage 224.

The information reception unit 232 receives an instruction from the controlling device 20 of the intermediate transport device 10 through the controlling device 120 of the intermediate transport device 110. The information transmission unit 234 transmits a processing state with respect to a sheet member P to the controlling device 20 of the intermediate transport device 10 through the controlling device 120 of the intermediate transport device 110.

Further, on the basis of a processing instruction, the transport control unit 236 controls, for example, the changing unit 216 of the intermediate transport device 210. On the basis of a processing instruction, the first control unit 238 transfers information between it and the controller 276 of the folding device 270. On the basis of a processing instruction, the second control unit 240 transfers information between it and the controller 286 of the folding device 280. On the basis of a processing instruction, the third control unit 242 transfers information between it and the controller 296 of the cutting device 290.

### Folding Device 270

The folding device 270 is a known folding device, and receives a sheet member P and performs a determined folding operation on the received sheet member P.

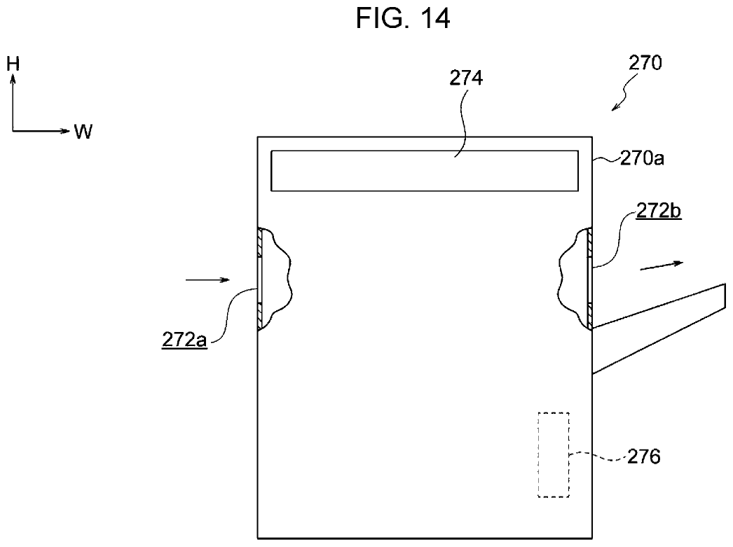

As shown in FIG. 14, the folding device 270 includes the controller 276 that controls each portion of the folding device 270, and a housing 270a of the folding device 270 has a reception port 272a that receives a sheet member P and a delivery port 272b that delivers the sheet member P that has been subjected to a folding operation. Specifically, as seen from a side of an operation screen 274 of the folding device 270, the reception port 272a is formed on another side in the width direction, and the delivery port 272b is formed on one side in the width direction.

In this structure, the folding device 270 receives a sheet member P from the other side in the width direction, and delivers the sheet member P that has been subjected to a folding operation to the one side in the width direction.

### Folding Device 280

The folding device 280 is a known folding device, and receives a sheet member P and performs a determined folding operation on the received sheet member P.

As shown in FIG. 6, the folding device 280 includes the controller 286 that controls each portion of the folding device 280, and a housing 280a of the folding device 280 has a reception port 282a that receives a sheet member P and a delivery port 282b that delivers the sheet member P that has been subjected to a folding operation. Specifically, as seen from a side of an operation screen 284 of the folding device 280, the reception port 282a is formed on a near side in the depth direction, and the delivery port 282b is formed on a far side in the depth direction.

In this structure, the folding device 280 receives a sheet member P from the near side in the depth direction, and delivers the sheet member P that has been subjected to a folding operation to the far side in the depth direction.

### Cutting Device 290

The cutting device 290 is a known cutting device, and receives a sheet member P and performs a determined cutting operation on the received sheet member P.

As shown in FIG. 7, the cutting device 290 includes the controller 296 that controls each portion of the cutting device 290, and a housing 290a of the cutting device 290 has a reception port 292a that receives a sheet member P and a delivery port 292b that delivers the sheet member P that has been subjected to a cutting operation. Specifically, as seen from a side of an operation screen 294 of the cutting device 290, the reception port 292a is formed on a far side in the depth direction, and the delivery port 292b is formed on a near side in the depth direction.

In this structure, the cutting device 290 receives a sheet member P from the far side in the depth direction and delivers the sheet member P that has been subjected to a cutting operation to the near side in the depth direction.

### Operation of Medium Processing System 100

### Part 1 of Operation

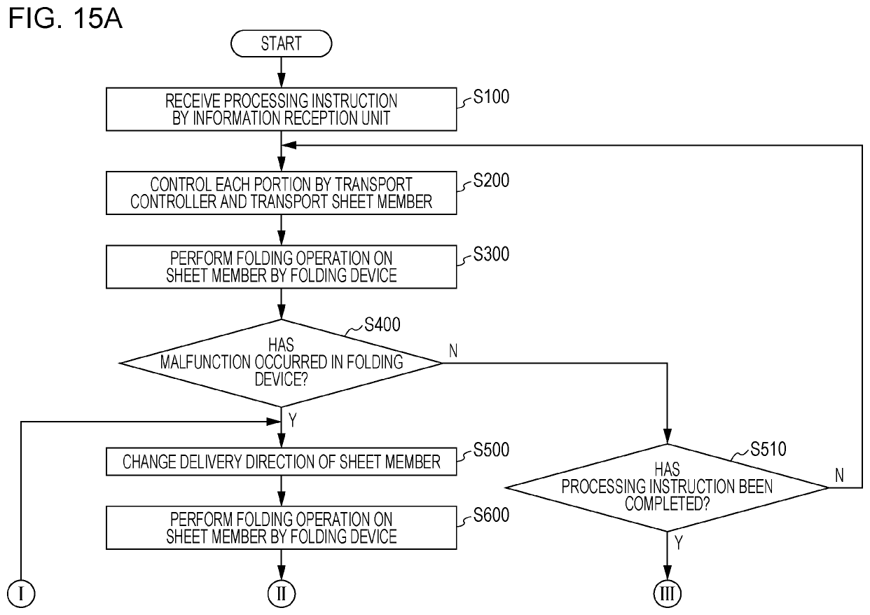

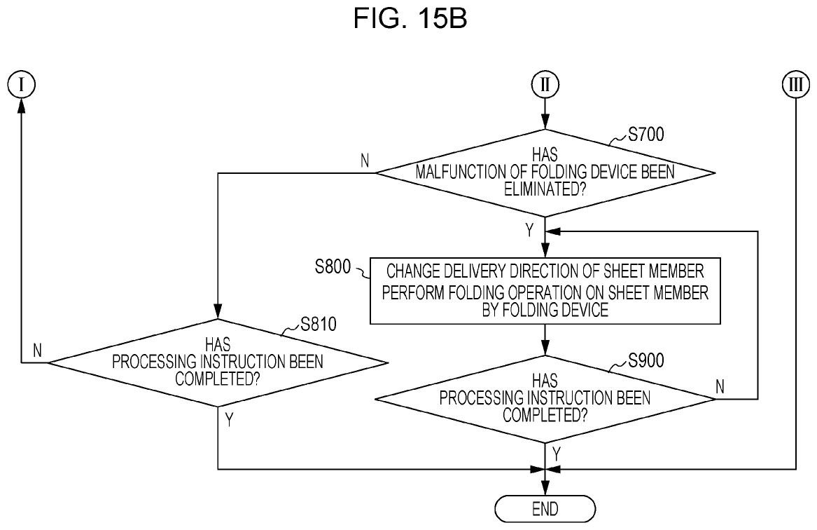

First, a sheet member P is delivered to the intermediate transport device 10 from the image forming apparatus 510 shown in FIG. 1, the sheet member P is delivered to the intermediate transport device 210 from the intermediate transport device 10 through the intermediate transport device 110, and the sheet member P is delivered to the folding device 280 from the intermediate transport device 210. A case in which a malfunction has occurred in the folding device 280 when the folding device 280 is performing a folding operation on the sheet member P is described by the flow diagram shown in FIGS. 15A and 15B.

Note that the folding device 280 to which the sheet member P is delivered from the intermediate transport device 210 and the folding device 80 to which a sheet member P is delivered from the intermediate transport device 10 are devices that are capable of performing the same folding operation on the sheet member P. The changing unit 16 of the intermediate transport device 10, the changing unit 116 of the intermediate transport device 110, and the changing unit 216 of the intermediate transport device 210 are such that the reception roller 16a, the reception roller 116a, and the reception roller 216a are each disposed at an initial position facing a corresponding one of the reception ports 14a, 114a, and 214a.

When a processing instruction for forming an image on a sheet member P and performing a folding operation on the sheet member P on which the image has been formed by using the folding device 280 is input to the operation screen 518 of the image forming apparatus 510 by a user, a process proceeds to Step S100.

In Step S100, the information reception unit 32 of the controlling device 20 receives a processing instruction from the controller 520 of the image forming apparatus 510. The controlling device 20 brings the changing unit 16 of the intermediate transport device 10 and the intermediate transport device 110 into a state capable of receiving the sheet member P. Further, the controlling device 20 brings the intermediate transport device 210 and the folding device 280 into a state capable of receiving the sheet member P through the controlling device 120.

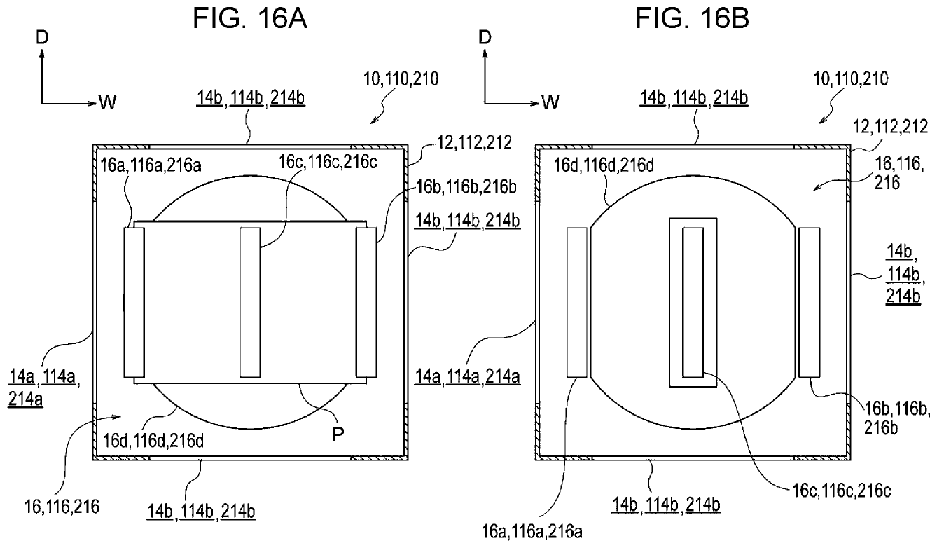

In Step S200, the image forming apparatus 510 forms an image on the sheet member P and delivers the sheet member P on which the image has been formed to the intermediate transport device 10. At the intermediate transport device 10, the transport control unit 36 of the controlling device 20 receives information about the size of the sheet member P from the controller 520, and controls the number of rotations of each roller on the basis of a detection timing of a sensor (not shown) that detects a leading end of the sheet member P. Therefore, as shown in FIG. 16A, the reception roller 16a and the intermediate roller 16c transport the received sheet member P to a prescribed position of the reception table 16d. Further, the transport control unit 36 of the controlling device 20 controls the number of rotations of each roller, and the delivery roller 16b delivers the sheet member P to the intermediate transport device 110 through the delivery port 14b (see FIG. 16B).

At the intermediate transport device 110, the transport control unit 136 of the controlling device 120 receives the information about the size of the sheet member P from the controlling device 20, and controls the number of rotations of each roller on the basis of a detection timing of a sensor (not shown) that detects the leading end of the sheet member P. Therefore, as shown in FIG. 16A, the reception roller 116a and the intermediate roller 116c transport the received sheet member P to a prescribed position of the reception table 116d. Further, the transport control unit 136 of the controlling device 120 controls the number of rotations of each roller, and the delivery roller 116b delivers the sheet member P to the intermediate transport device 210 through the delivery port 114b (see FIG. 16B).

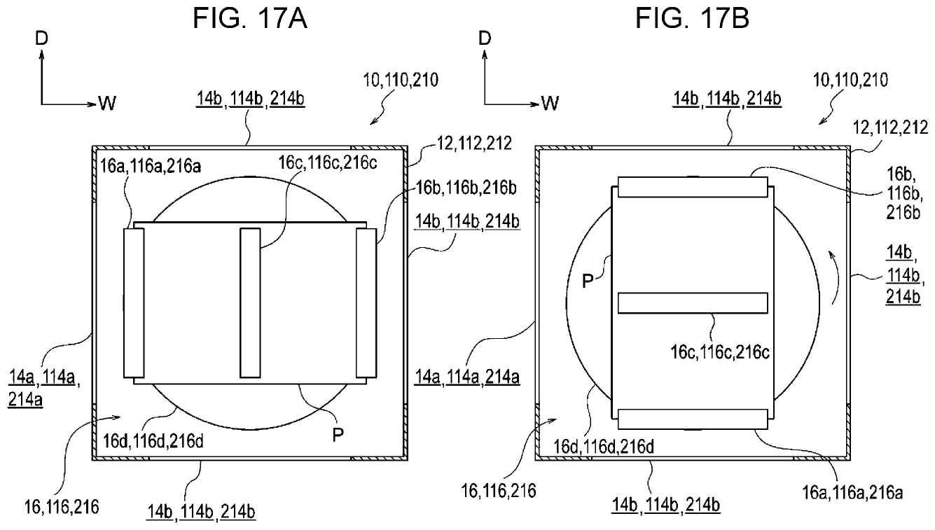

At the intermediate transport device 210, the transport control unit 236 of the controlling device 220 controls the number of rotations of each roller on the basis of a detection timing of a sensor (not shown) that detects the leading end of the sheet member P. Therefore, as shown in FIG. 17A, the reception roller 216a and the intermediate roller 216c transport the received sheet member P to a prescribed position of the reception table 216d.

The driving unit 216g shown in FIG. 12A rotates the shaft portion 216e. Therefore, as shown in FIG. 17B, the reception roller 216a, the delivery roller 216b, the intermediate roller 216c, and the reception table 216d rotate together counterclockwise by 90 degrees. Further, the transport control unit 236 of the controlling device 220 controls the number of rotations of each roller and the delivery roller 216b delivers the sheet member P to the folding device 280 (see FIG. 1) through the delivery port 214b. Note that when the delivery roller 216b delivers the sheet member P, the changing unit 216 of the intermediate transport device 210 is restored to its initial position.

In Step S300, the second control unit 240 of the controlling device 220 issues an instruction to the controller 286 of the folding device 280, and the folding device 280 shown in FIG. 6, due to control of the controller 286, receives the sheet member P delivered from the intermediate transport device 210 through the reception port 282a and performs a folding operation on the received sheet member P.

In Step S400, the controller 286 of the folding device 280 determines whether or not the sheet member P subjected to the folding operation has been delivered through the delivery port 282b. If the sheet member P subjected to the folding operation has been delivered through the delivery port 282b, a malfunction has not occurred in the folding device 280, whereas if the sheet member P subjected to the folding operation has not been delivered through the delivery port 282b, a malfunction has occurred in the folding device 280. That is, in Step S400, the controller 286 of the folding device 280 determines whether or not a malfunction has occurred in the folding device 280.

If a malfunction has occurred in the folding device 280, the process proceeds to Step S500, whereas if a malfunction has not occurred in the folding device 280, the process proceeds to Step S510.

In Step S500, the information reception unit 32 of the controlling device 20 receives information about the malfunction of the folding device 280 through the controlling device 120 and the controlling device 220, and the transport control unit 36 of the controlling device 20 controls the changing unit 16 and changes a delivery destination of a sheet member P to the folding device 80 from the folding device 280. The second control unit 40 of the controlling device 20 issues an instruction to the controller 86 of the folding device 80, and the folding device 80 shown in FIG. 6 is brought into a state capable of receiving the sheet member P due to control of the controller 86.

Specifically, the image forming apparatus 510 forms an image on the sheet member P and delivers the sheet member P on which the image has been formed to the intermediate transport device 10. At the intermediate transport device 10, the transport control unit 36 of the controlling device 20 controls the number of rotations of each roller on the basis of a detection timing of a sensor (not shown) that detects a leading end of the sheet member P. Therefore, as shown in FIG. 17A, the reception roller 16a and the intermediate roller 16c transport the received sheet member P to a prescribed position of the reception table 16d.

The driving unit 16g shown in FIG. 4A rotates the shaft portion 16e. Therefore, as shown in FIG. 17B, the reception roller 16a, the delivery roller 16b, the intermediate roller 16c, and the reception table 16d rotate together counterclockwise by 90 degrees. Further, the transport control unit 36 of the controlling device 20 controls the number of rotations of each roller and the delivery roller 16b delivers the sheet member P to the folding device 80 (see FIG. 1) through the delivery port 14b. Note that when the delivery roller 16b delivers the sheet member P, the changing unit 16 of the intermediate transport device 10 is restored to its initial position.

In Step S600, the second control unit 40 of the controlling device 20 issues an instruction to the controller 86 of the folding device 80, and the folding device 80 shown in FIG. 6, due to control of the controller 86, receives the sheet member P delivered from the intermediate transport device 10 through the reception port 82a and performs a folding operation on the received sheet member P. Further, the folding device 80 delivers the sheet member P subjected to the folding operation through the delivery port 82b.

In Step S700, the second control unit 240 of the controlling device 220 receives information about whether the malfunction of the folding device 280 has been eliminated from the controller 286 of the folding device 280. Specifically, if the malfunction is occurring in the folding device 280 due to jamming of the sheet member P, the malfunction of the folding device 280 is eliminated by removing the jammed sheet member P. The information is received by the second control unit 240 of the controlling device 220 from the controller 286 of the folding device 280.

If the malfunction of the folding device 280 has been eliminated, the process proceeds to Step S800, whereas if the malfunction has not been eliminated, the process proceeds to Step S810.

In Step S800, the first control unit 38 of the controlling device 20 receives information about the elimination of the malfunction of the folding device 280 through the controlling device 120 and the controlling device 220, and the transport control unit 36 of the controlling device 20 changes the delivery destination of a sheet member P to the folding device 280 from the folding device 80. The first control unit 38 of the controlling device 20 issues an instruction to the controller 286 of the folding device 280 through the controlling device 120 and the controlling device 220, and the folding device 280 shown in FIG. 6 is brought into a state capable of receiving the sheet member P due to control of the controller 286.

Then, as described in Step S200 and Step S300, the image forming apparatus 510 forms an image on the sheet member P, and delivers the sheet member P on which the image has been formed to the folding device 280 through the intermediate transport device 10, the intermediate transport device 110, and the intermediate transport device 210. Then, the folding device 280 shown in FIG. 6 receives the sheet member P delivered from the intermediate transport device 210 through the reception port 282a, and performs a folding operation on the received sheet member P.

In Step S900, the completion determination unit 44 of the controlling device 20 determines whether or not the processing instruction issued by the user has been completed, and, if it has been completed, the series of operations end. In contrast, if it has not be completed, the process returns to Step S800 and the aforementioned steps are repeated again.

In Step S400, if a malfunction has not occurred in the folding device 280 and the process has proceeded to Step S510, in Step S510, the completion determination unit 44 of the controlling device 20 determines whether or not the processing instruction issued by the user has been completed, and, if it has been completed, the series of operations end. In contrast, if it has not been completed, the process returns to Step S200 and the aforementioned steps are repeated again.

In Step S700, if the malfunction of the folding device 280 has not been eliminated and the process has proceeded to Step S810, in Step S810, the completion determination unit 44 of the controlling device 20 determines whether or not the processing instruction issued by the user has been completed, and, if it has been completed, the series of operations end. In contrast, if it has not been completed, the process returns to Step S500 and the aforementioned steps are repeated again.

### Part 2 of Operation

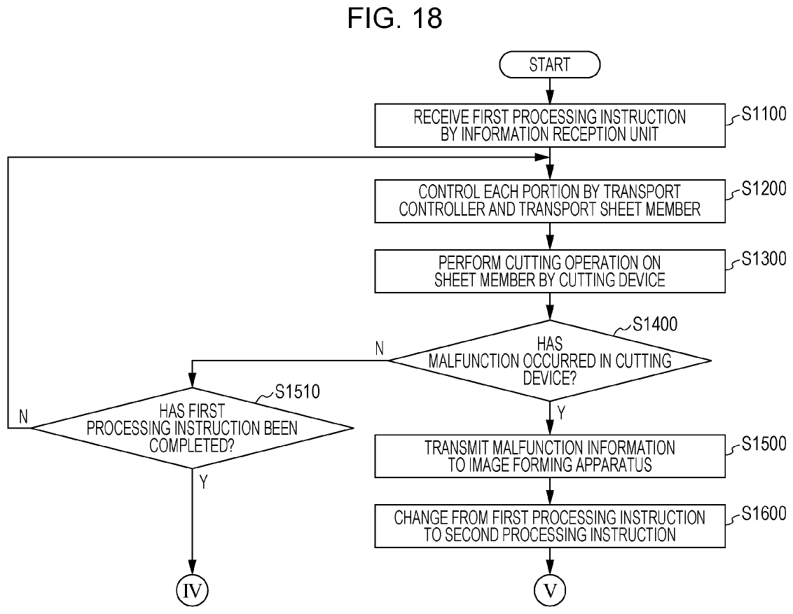

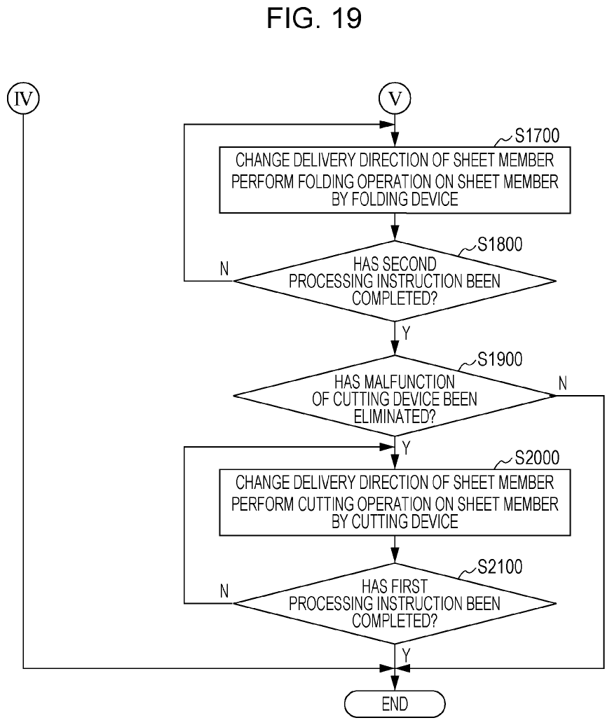

Next, a sheet member P is delivered to the intermediate transport device 10 from the image forming apparatus 510, the sheet member P is delivered to the intermediate transport device 210 from the intermediate transport device 10 through the intermediate transport device 110, and the sheet member P is delivered to the cutting device 290 from the intermediate transport device 210. A case in which a malfunction has occurred in the cutting device 290 when the cutting device 290 is performing a cutting operation on the sheet member P is described by the flow diagrams shown in FIGS. 18 and 19.

Note that the cutting device 290 to which a sheet member P is delivered from the intermediate transport device 210, the cutting device 90, and the cutting device 190 are not capable of performing the same cutting operation on the sheet member P.

The changing unit 16 of the intermediate transport device 10, the changing unit 116 of the intermediate transport device 110, and the changing unit 216 of the intermediate transport device 210 are such that the reception roller 16a, the reception roller 116a, and the reception roller 216a are each disposed at an initial position facing a corresponding one of the reception ports 14a, 114a, and 214a.

When a first processing instruction for forming an image on a sheet member P and performing a cutting operation on the sheet member P on which the image has been formed by using the cutting device 290 is input to the operation screen 518 of the image forming apparatus 510 by a user, a process proceeds to Step S1100. Note that a second processing instruction for forming an image on a sheet member P and performing a folding operation on the sheet P on which the image has been formed by using the folding device 80 is input to the operation screen 518 of the image forming apparatus 510 by the user so as to be executed after completing the first processing instruction.

In Step S1100, the information reception unit 32 of the controlling device 20 receives the first processing instruction from the controller 520 of the image forming apparatus 510. The controlling device 20 brings the changing unit 16 of the intermediate transport device 10 and the intermediate transport device 110 into a state capable of receiving the sheet member P. Further, the controlling device 20 brings the intermediate transport device 210 and the cutting device 290 into a state capable of receiving the sheet member P through the controlling device 120.

In Step S1200, the image forming apparatus 510 forms an image on the sheet member P and delivers the sheet member P on which the image has been formed to the intermediate transport device 10. At the intermediate transport device 10, the transport control unit 36 of the controlling device 20 receives information about the size of the sheet member P from the controller 520, and controls the number of rotations of each roller on the basis of a detection timing of a sensor (not shown) that detects a leading end of the sheet member P. Therefore, as shown in FIG. 16A, the reception roller 16a and the intermediate roller 16c transport the received sheet member P to a prescribed position of the reception table 16d. Further, the transport control unit 36 of the controlling device 20 controls the number of rotations of each roller, and the delivery roller 16b delivers the sheet member P to the intermediate transport device 110 through the delivery port 14b (see FIG. 16B).

At the intermediate transport device 110, the transport control unit 136 of the controlling device 120 receives the information about the size of the sheet member P from the controlling device 20, and controls the number of rotations of each roller on the basis of a detection timing of a sensor (not shown) that detects the leading end of the sheet member P. Therefore, as shown in FIG. 16A, the reception roller 116a and the intermediate roller 116c transport the received sheet member P to a prescribed position of the reception table 116d. Further, the transport control unit 136 of the controlling device 120 controls the number of rotations of each roller, and the delivery roller 116b delivers the sheet member P to the intermediate transport device 210 through the delivery port 114b (see FIG. 16B).

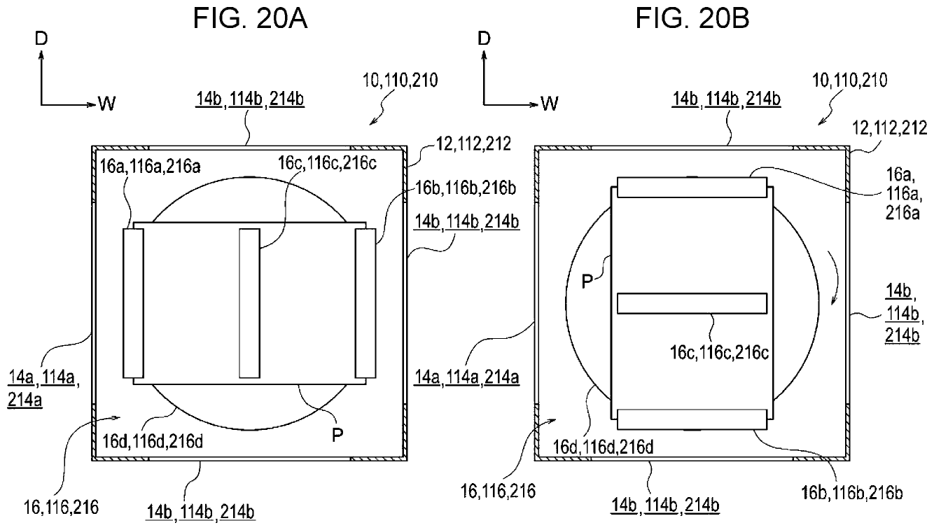

At the intermediate transport device 210, the transport control unit 236 of the controlling device 220 receives the information about the size of the sheet member P from the controlling device 20 through the controlling device 120, and controls the number of rotations of each roller on the basis of a detection timing of a sensor (not shown) that detects the leading end of the sheet member P. Therefore, as shown in FIG. 20A, the reception roller 216a and the intermediate roller 216c transport the received sheet member P to a prescribed position of the reception table 216d.

The driving unit 216g shown in FIG. 12A rotates the shaft portion 216e. Therefore, as shown in FIG. 20B, the reception roller 216a, the delivery roller 216b, the intermediate roller 216c, and the reception table 216d rotate together clockwise by 90 degrees. Further, the transport control unit 236 of the controlling device 220 controls the number of rotations of each roller, and the delivery roller 216b delivers the sheet member P to the cutting device 290 (see FIG. 1) through the delivery port 214b. Note that when the delivery roller 216b delivers the sheet member P, the changing unit 216 of the intermediate transport device 210 is restored to its initial position.

In Step S1300, the third control unit 242 of the controlling device 220 issues an instruction to the controller 296 of the cutting device 290, and the cutting device 290 shown in FIG. 7, due to control of the controller 296, receives the sheet member P delivered from the intermediate transport device 210 through the reception port 292a and performs a cutting operation on the received sheet member P.

In Step S1400, the controller 296 of the cutting device 290 determines whether or not the sheet member P subjected to the cutting operation has been delivered through the delivery port 292b. If the sheet member P subjected to the cutting operation has been delivered through the delivery port 292b, a malfunction has not occurred in the cutting device 290, whereas if the sheet member P subjected to the cutting operation has not been delivered through the delivery port 292b, a malfunction has occurred in the cutting device 290. That is, in Step S1400, the controller 296 of the cutting device 290 determines whether or not a malfunction has occurred in the cutting device 290.

If a malfunction has occurred in the cutting device 290, the process proceeds to Step S1500, whereas if a malfunction has not occurred in the cutting device 290, the process proceeds to Step S1510.

In Step S1500, the first control unit 38 of the controlling device 20 receives information about the malfunction of the cutting device 290 through the controlling device 120 and the controlling device 220, and the information transmission unit 34 of the controlling device 20 transmits the information about the malfunction of the cutting device 290 to the controller 520 of the image forming apparatus 510.

In Step S1600, the controller 520 of the image forming apparatus 510 receives the information about the malfunction of the cutting device 290 to change from the first processing instruction used by the cutting device 290 to the second processing instruction used by the folding device 80.

In Step S1700, the controller 520 of the image forming apparatus 510 controls the image forming apparatus 510, and the image forming apparatus 510 forms an image on a sheet member P and delivers the sheet member P on which the image has been formed to the intermediate transport device 10.

At the intermediate transport device 10, the transport control unit 36 of the controlling device 20 controls the number of rotations of each roller on the basis of a detection timing of a sensor (not shown) that detects a leading end of the sheet member P. Therefore, as shown in FIG. 17A, the reception roller 16a and the intermediate roller 16c transport the received sheet member P to a prescribed position of the reception table 16d.

The driving unit 16g shown in FIG. 4A rotates the shaft portion 16e. Therefore, as shown in FIG. 17B, the reception roller 16a, the delivery roller 16b, the intermediate roller 16c, and the reception table 16d rotate together counterclockwise by 90 degrees. Further, the transport control unit 36 of the controlling device 20 controls the number of rotations of each roller, and the delivery roller 16b delivers the sheet member P to the folding device 80 (see FIG. 1) through the delivery port 14b. Note that when the delivery roller 16b delivers the sheet member P, the changing unit 16 of the intermediate transport device 10 is restored to its initial position.

The second control unit 40 of the controlling device 20 issues an instruction to the controller 86 of the folding device 80, and the folding device 80 shown in FIG. 6, due to control of the controller 86, is brought into a state capable of receiving the sheet member P. Then, the folding device 80 shown in FIG. 6, due to the control of the controller 86, receives the sheet member P delivered from the intermediate transport device 10 through the reception port 82a, performs a folding operation on the received sheet P, and delivers the sheet member P through the delivery port 82b.

In Step S1800, the completion determination unit 44 of the controlling device 20 determines whether or not the second processing instruction has been completed. If it has been completed, the process proceeds to Step S1900, whereas, if it has not been completed, the process returns to Step S1700 and the aforementioned steps are repeated again. In this way, the controlling device 20 causes the folding device 80 to perform the post-processing on the sheet member P until the entire post-processing of the sheet member P by the folding device 80 ends.

In Step S1900, the first control unit 38 of the controlling device 20 receives information about whether the malfunction of the cutting device 290 has been eliminated from the controller 296 of the cutting device 290 through the controlling device 120 and the controlling device 220. Specifically, if the malfunction is occurring in the cutting device 290 due to jamming of the sheet member P, the malfunction of the cutting device 290 is eliminated by removing the jammed sheet member P. The information is received by the first control unit 38 of the controlling device 20 from the controller 296 of the cutting device 290 through the controlling device 120 and the controlling device 220.

If the malfunction has been eliminated, the process proceeds to Step S2000, whereas if the malfunction has not been eliminated, the series of operations end.

In Step S2000, the controller 520 of the image forming apparatus 510 receives information about the elimination of the malfunction of the cutting device 290, and a change is made to a portion of the first processing instruction that is not completed.

Specifically, as described in Step S1200 and Step S1300, the image forming apparatus 510 forms an image on a sheet member P, and delivers the sheet member P on which the image has been formed to the cutting device 290 through the intermediate transport device 10, the intermediate transport device 110, and the intermediate transport device 210. Then, the cutting device 290 shown in FIG. 7 receives the sheet member P delivered from the intermediate transport device 210 through the reception port 292a, and performs a cutting operation on the received sheet member P.

In Step S2100, the completion determination unit 44 of the controlling device 20 determines whether or not the first processing instruction has been completed. If it has been completed, the series of operations end. If it has not be completed, the process returns to Step S2000 and the aforementioned steps are repeated again.

In Step S1400, if a malfunction has not occurred in the cutting device 290 and the process has proceeded to Step S1510, in Step S1510, the completion determination unit 44 of the controlling device 20 determines whether or not the first processing instruction issued by the user has been completed, and, if it has been completed, the series of operations end. In contrast, if it has not been completed, the process returns to Step S1200 and the aforementioned steps are repeated again.

### Part 3 of Operation

A sheet member P is delivered to the intermediate transport device 10 from the image forming apparatus 510, the sheet member P is delivered to the folding device 80 from the intermediate transport device 10, and a folding step of performing a folding operation on the sheet member P by the folding device 80 is performed by a third processing instruction. In addition, a sheet member P is delivered to the intermediate transport device 10, the intermediate transport device 110, and the intermediate transport device 210 from the image forming apparatus 510, the sheet member P is delivered to the cutting device 290 from the intermediate transport device 210, and a cutting step of performing a cutting operation on the sheet member P by the cutting device 290 is performed by a fourth processing instruction.

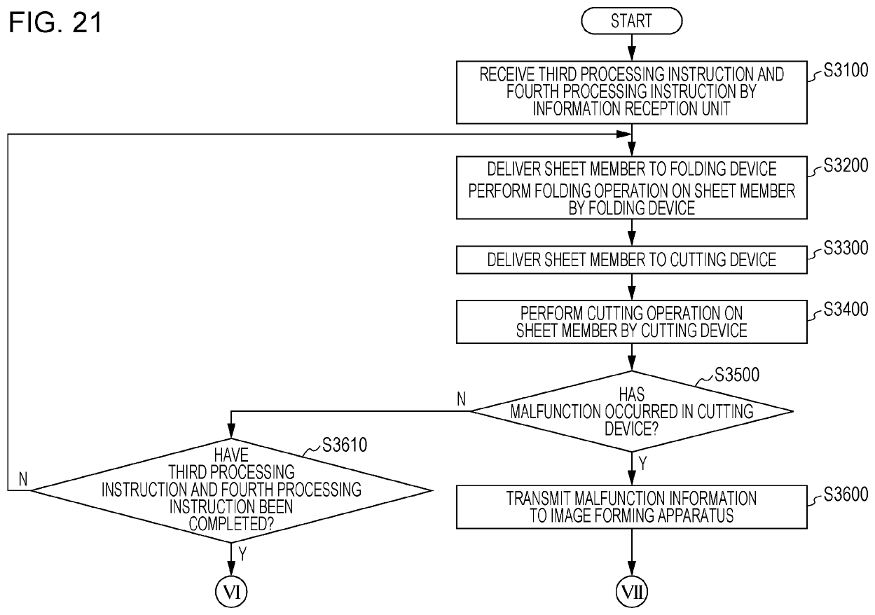

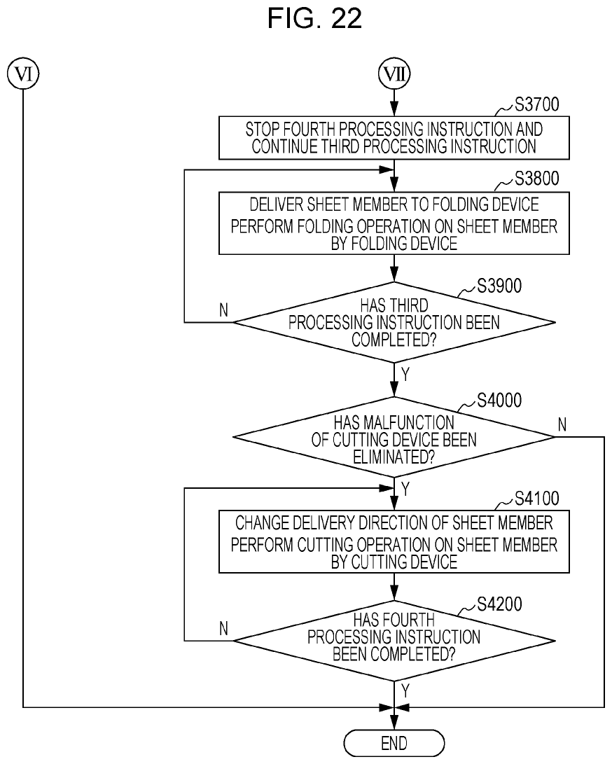

A case in which a malfunction has occurred in the cutting device 290 when the folding step and the cutting step are alternately performed is described by using the flow diagrams shown in FIGS. 21 and 22. Here, “alternately” means “periodically switching”, and is not limited to switching after every one step. That is, “alternately” also means switching after every multiple steps.

The changing unit 16 of the intermediate transport device 10, the changing unit 116 of the intermediate transport device 110, and the changing unit 216 of the intermediate transport device 210 are such that the reception roller 16a, the reception roller 116a, and the reception roller 216a are each disposed at an initial position facing a corresponding one of the reception ports 14a, 114a, and 214a.

When the third processing instruction and the fourth processing instruction are input to the operation screen 518 of the image forming apparatus 510 by a user such that the aforementioned folding step and the aforementioned cutting step are alternately performed, a process proceeds to Step S3100.

In Step S3100, the information reception unit 32 of the controlling device 20 receives the third processing instruction and the fourth processing instruction from the controller 520 of the image forming apparatus 510. The controlling device 20 brings the changing unit 16 of the intermediate transport device 10, the folding device 80, and the intermediate transport device 110 into a state capable of receiving a sheet member P. Further, the controlling device 20 brings the intermediate transport device 210 and the cutting device 290 into a state capable of receiving a sheet member P through the controlling device 120.

In Step S3200, the image forming apparatus 510 forms an image on the sheet member P and delivers the sheet member P on which the image has been formed to the intermediate transport device 10. At the intermediate transport device 10, the transport control unit 36 of the controlling device 20 controls the number of rotations of each roller on the basis of a detection timing of a sensor (not shown) that detects a leading end of the sheet member P. Therefore, as shown in FIG. 17A, the reception roller 16a and the intermediate roller 16c transport the received sheet member P to a prescribed position of the reception table 16d.

The driving unit 16g shown in FIG. 4A rotates the shaft portion 16e. Therefore, as shown in FIG. 17B, the reception roller 16a, the delivery roller 16b, the intermediate roller 16c, and the reception table 16d rotate together counterclockwise by 90 degrees. Further, the transport control unit 36 of the controlling device 20 controls the number of rotations of each roller and the delivery roller 16b delivers the sheet member P to the folding device 80 (see FIG. 1) through the delivery port 14b. Note that when the delivery roller 16b delivers the sheet member P, the changing unit 16 of the intermediate transport device 10 is restored to its initial position.

The folding device 80 shown in FIG. 6, due to control of the controller 86, is brought into a state capable of receiving the sheet member P. Then, the folding device 80, due to the control of the controller 86, receives the sheet member P delivered from the intermediate transport device 10 through the reception port 82a, performs a folding operation on the received sheet P, and delivers the sheet member P through the delivery port 82b.

In Step S3300, the image forming apparatus 510 forms an image on a sheet member P and delivers the sheet member P on which the image has been formed to the intermediate transport device 10. At the intermediate transport device 10, the transport control unit 36 of the controlling device 20 receives information about the size of the sheet member P from the controller 520, and controls the number of rotations of each roller on the basis of a detection timing of a sensor (not shown) that detects a leading end of the sheet member P. Therefore, as shown in FIG. 16A, the reception roller 16a and the intermediate roller 16c transport the received sheet member P to a prescribed position of the reception table 16d. Further, the transport control unit 36 of the controlling device 20 controls the number of rotations of each roller, and the delivery roller 16b delivers the sheet member P to the intermediate transport device 110 through the delivery port 14b (see FIG. 16B).

At the intermediate transport device 110, the transport control unit 136 of the controlling device 120 receives the information about the size of the sheet member P from the controlling device 20, and controls the number of rotations of each roller on the basis of a detection timing of a sensor (not shown) that detects a leading end of the sheet member P. Therefore, as shown in FIG. 16A, the reception roller 116a and the intermediate roller 116c transport the received sheet member P to a prescribed position of the reception table 116d. Further, the transport control unit 136 of the controlling device 120 controls the number of rotations of each roller, and the delivery roller 116b delivers the sheet member P to the intermediate transport device 210 through the delivery port 114b (see FIG. 16B).

At the intermediate transport device 210, the transport control unit 236 of the controlling device 220 receives the information about the size of the sheet member P from the controlling device 20 through the controlling device 120, and controls the number of rotations of each roller on the basis of a detection timing of a sensor (not shown) that detects the leading end of the sheet member P. Therefore, as shown in FIG. 20A, the reception roller 216a and the intermediate roller 216c transport the received sheet member P to a prescribed position of the reception table 216d.

The driving unit 216g shown in FIG. 12A rotates the shaft portion 216e. Therefore, as shown in FIG. 20B, the reception roller 216a, the delivery roller 216b, the intermediate roller 216c, and the reception table 216d rotate together clockwise by 90 degrees. Further, the transport control unit 236 of the controlling device 220 controls the number of rotations of each roller, and the delivery roller 216b delivers the sheet member P to the cutting device 290 (see FIG. 1) through the delivery port 214b. Note that when the delivery roller 216b delivers the sheet member P, the changing unit 216 of the intermediate transport device 210 is restored to its initial position.

In Step S3400, the third control unit 242 of the controlling device 220 issues an instruction to the controller 296 of the cutting device 290, and the cutting device 290 shown in FIG. 7, due to control of the controller 296, receives the sheet member P delivered from the intermediate transport device 210 through the reception port 292a and performs a cutting operation on the received sheet member P.

In Step S3500, the controller 296 of the cutting device 290 determines whether or not the sheet member P subjected to the cutting operation has been delivered through the delivery port 292b. If the sheet member P subjected to the cutting operation has been delivered through the delivery port 292b, a malfunction has not occurred in the cutting device 290, whereas if the sheet member P subjected to the cutting operation has not been delivered through the delivery port 292b, a malfunction has occurred in the cutting device 290. That is, in Step S3500, the controller 296 of the cutting device 290 determines whether or not a malfunction has occurred in the cutting device 290.

If a malfunction has occurred in the cutting device 290, the process proceeds to Step S3600, whereas if a malfunction has not occurred in the cutting device 290, the process proceeds to Step S3610.

In Step S3600, the first control unit 38 of the controlling device 20 receives information about the malfunction of the cutting device 90 through the controlling device 120 and the controlling device 220, and the information transmission unit 34 of the controlling device 20 transmits the information about the malfunction of the cutting device 290 to the controller 520 of the image forming apparatus 510.

In Step S3700, the controller 520 of the image forming apparatus 510 receives the information about the malfunction of the cutting device 290, stops the fourth processing instruction using the cutting device 290, and continues only the third processing instruction using the folding device 80.

In Step S3800, the image forming apparatus 510 forms an image on a sheet member P, and delivers the sheet member P on which the image has been formed to the intermediate transport device 10. At the intermediate transport device 10, the transport control unit 36 of the controlling device 20 controls the number of rotations of each roller on the basis of a detection timing of a sensor (not shown) that detects a leading end of the sheet member P. Therefore, as shown in FIG. 17A, the reception roller 16a and the intermediate roller 16c transport the received sheet member P to a prescribed position of the reception table 16d.

The driving unit 16g shown in FIG. 4A rotates the shaft portion 16e. Therefore, as shown in FIG. 17B, the reception roller 16a, the delivery roller 16b, the intermediate roller 16c, and the reception table 16d rotate together counterclockwise by 90 degrees. Further, the transport control unit 36 of the controlling device 20 controls the number of rotations of each roller, and the delivery roller 16b delivers the sheet member P to the folding device 80 (see FIG. 1) through the delivery port 14b. Note that when the delivery roller 16b delivers the sheet member P, the changing unit 16 of the intermediate transport device 10 is restored to its initial position.

The second control unit 40 of the controlling device 20 issues an instruction to the controller 86 of the folding device 80, and the folding device 80 shown in FIG. 6, due to control of the controller 86, is brought into a state capable of receiving the sheet P. Then, the folding device 80 shown in FIG. 6, due to the control of the controller 86, receives the sheet member P delivered from the intermediate transport device 10 through the reception port 82a, performs a folding operation on the received sheet member P, and delivers the sheet member P through the delivery port 82b.

In Step S3900, the completion determination unit 44 determines whether or not the third processing instruction has been completed. If it has been completed, the process proceeds to Step S4000, whereas, if it has not been completed, the process returns to Step S3800 and the aforementioned steps are repeated again.

In Step S4000, the first control unit 38 of the controlling device 20 receives information about whether the malfunction of the cutting device 290 has been eliminated from the controller 296 of the cutting device 290 through the controlling device 120 and the controlling device 220. Specifically, if the malfunction is occurring in the cutting device 290 due to jamming of the sheet member P, the malfunction of the cutting device 290 is eliminated by removing the jammed sheet member P. The information is received by the first control unit 38 of the controlling device 20 from the controller 296 of the cutting device 290 through the controlling device 120 and the controlling device 220.

If the malfunction has been eliminated, the process proceeds to Step S4100, whereas if the malfunction has not been eliminated, the series of operations end.

In Step S4100, the controller 520 of the image forming apparatus 510 receives information about the elimination of the malfunction of the cutting device 290, and a portion of the fourth processing instruction that is not completed is executed.

Specifically, as described in Step S3300 and Step S3400, the image forming apparatus 510 forms an image on a sheet member P, and delivers the sheet member P on which the image has been formed to the cutting device 290 through the intermediate transport device 10, the intermediate transport device 110, and the intermediate transport device 210. Then, the cutting device 290 shown in FIG. 7 receives the sheet member P delivered from the intermediate transport device 210 through the reception port 292a, and performs a cutting operation on the received sheet member P.

In Step S4200, the completion determination unit 44 of the controlling device 20 determines whether or not the fourth processing instruction has been completed. If it has been completed, the series of operations end. If it has not been completed, the process returns to Step S4100 and the aforementioned steps are repeated again.

In Step S3500, if a malfunction has not occurred in the cutting device 290 and the process has proceeded to Step S3610, in Step S3610, the completion determination unit 44 of the controlling device 20 determines whether or not the third processing instruction and the fourth processing instruction issued by the user have been completed, and, if they have been completed, the series of operations end. In contrast, if they have not been completed, the process returns to Step S3200 and the aforementioned steps are repeated again.

### Recapitulation

As described above, in the medium processing system 100, the controlling device 20 of the intermediate transport device 10 that receives a sheet member P from the image forming apparatus 510 communicates with the folding device 80, the cutting device 90, the image forming apparatus 510, and the intermediate transport device 110. The controlling device 120 communicates with the folding device 180, the cutting device 190, the intermediate transport device 10, and the intermediate transport device 210. Further, the controlling device 220 communicates with the folding device 270, the folding device 280, the cutting device 290, and the intermediate transport device 110.

The controlling device 120 controls the folding device 180 and the cutting device 190 on the basis of an instruction from the controlling device 20 of the intermediate transport device 10. The controlling device 220 controls the folding device 270, the folding device 280, and the cutting device 290 on the basis of an instruction from the controlling device 20 that is transmitted through the controlling device 120.

Therefore, the controlling device 20 only has a communication port 26a for communication with the image forming apparatus 510, a communication port 26b for communication with the intermediate transport device 110, a communication port 26c for communication with the folding device 80, and a communication port 26d for communication with the cutting device 90.

On the other hand, when one controlling device directly controls the post-processing devices of the entire system, the number of communication ports of the controlling device is increased. An increase in the number of post-processing devices when the number of intermediate transport devices is increased may cause an increase in the number of communication ports.

However, as described above, in the medium processing system 100 according to the exemplary embodiment, the controlling device 20 only has a communication port 26a for communication with the image forming apparatus 510, a communication port 26b for communication with the intermediate transport device 110, a communication port 26c for communication with the folding device 80, and a communication port 26d for communication with the cutting device 90. The controlling device 120 controls the folding device 180 and the cutting device 190 on the basis of an instruction from the controlling device 20 of the intermediate transport device 10. The controlling device 220 controls the folding device 270, the folding device 280, and the cutting device 290 on the basis of an instruction from the controlling device 20 that is transmitted through the controlling device 120.

In the medium processing system 100, as described in part 1 of the operation, even if a malfunction occurs in the folding device 280, medium processing is continued by using the folding device 80. Further, as described in part 2 of the operation, even if a malfunction occurs in the cutting device 290, medium processing is continued by using the folding device 80. Still further, as described in part 3 of the operation, even if a malfunction occurs in the cutting device 290, medium processing is continued by using only the folding device 80. In this way, even if a malfunction occurs in one post-processing device, medium processing is continued.

In the medium processing system 100, as described in part 1 of the operation, when the post-processing of the folding device 80 is the same as the post-processing of the folding device 280 in which a malfunction has occurred, the same post-processing is continued on a sheet member P by using the folding device 80.

In the medium processing system 100, as described in part 2 of the operation, when the post-processing of the folding device 80 differs from the post-processing of the cutting device 290 in which a malfunction has occurred, the controller 520 causes the image forming apparatus 510 to deliver a sheet member P that is subjected to post-processing by the folding device 80. Therefore, even if the post-processing of the folding device 80 and the post-processing of the cutting device 290 differ from each other, medium processing is continued.

In the medium processing system 100, as described in part 2 of the operation, even if the malfunction of the cutting device 290 in which the malfunction has occurred is eliminated, the post-processing by the folding device 80 is continued and the second processing instruction is completed.

In the medium processing system 100, as described in part 3 of the operation, when the cutting device 290 and the folding device 80 alternately perform post-processing on a sheet member P, if a malfunction occurs in the cutting device 290 and the folding device 80 is capable of performing post-processing, the controlling device 20 causes only the folding device 80 to perform post-processing on the sheet member P. In this way, even if a malfunction has occurred in one post-processing device, medium processing is continued.

Note that although the present disclosure is described in detail with regard to a specific exemplary embodiment, the present disclosure is not limited to such an exemplary embodiment, and it is obvious to those skilled in the art that, for the present disclosure, various other exemplary embodiments are possible within the scope of the present disclosure. For example, in the exemplary embodiment above, the image forming apparatus 510 is described as an example of a pre-processing device. However, the pre-processing device may be a pre-processing stacker device in which printed sheet members P are stacked in the inside thereof, or an inkjet image forming apparatus.

In the exemplary embodiment above, although not particularly mentioned, for example, an electricity removing device that removes the electricity on a sheet member P, an examining device that examines an image, and a buffer device that temporarily accumulates sheet members P and delivers them to a following device may be provided between the image forming apparatus 510 and the intermediate transport device 10. In such a case, multiple devices disposed upstream of the intermediate transport device 10 in a transport direction of a sheet member P become one pre-processing device.

In the exemplary embodiment above, in part 1 of the operation, although medium processing is continued by using the folding device 80 when a malfunction occurs in the folding device 280, for example, medium processing may be continued by using the folding device 280 when a malfunction occurs in the folding device 80. Further, medium processing may be continued by using the folding device 180 when a malfunction occurs in the folding device 280.

In the exemplary embodiment above, in part 2 of the operation, although medium processing is continued by using the folding device 80 by changing the post-processing when a malfunction occurs in the cutting device 290, for example, medium processing may be continued by using the cutting device 290 by changing the post-processing when a malfunction occurs in the folding device 80. Further, medium processing may be continued by using the folding device 180 by changing the post-processing when a malfunction occurs in the cutting device 290.

In the exemplary embodiment above, in part 3 of the operation, when the folding step by the folding device 80 and the cutting step by the cutting device 290 are alternately performed, only the folding step by the folding device 80 is continued when a malfunction occurs in the cutting device 290. However, for example, when the folding step by the folding device 80 and the cutting step by the cutting device 290 are alternately performed, only the cutting step by the cutting device 290 may be continued when a malfunction occurs in the folding device 80. Alternatively, for example, when a folding step by the folding device 180 and the cutting step by the cutting device 290 are alternately performed, only the cutting step by the cutting device 290 may be continued when a malfunction occurs in the folding device 180.

In the exemplary embodiment above, the folding device 270, the folding devices 80, 180, and 280, and the cutting devices 90, 190, and 290 are described as examples of post-processing devices. However, the post-processing devices may be, for example, saddle stitching devices, binder devices, slit devices, press devices, or post-processing stacker devices.

In the exemplary embodiment above, the intermediate transport device 10 has a square shape in plan view, and each side surface has a reception port or a delivery port. However, the intermediate transport device 10 may have a polygonal shape, such as a triangular shape, a pentagonal shape, or a hexagonal shape, in plan view, and each side surface may have a reception port or a delivery port.

In the exemplary embodiment above, although the intermediate transport device 10 has one reception port 14a that receives a sheet member P and three delivery ports 14b that deliver a sheet member P, the number of reception ports may be two and the number of delivery ports may be two, or the number of reception ports may be three and the number of delivery ports may be one.

In the exemplary embodiment above, the intermediate transport device 110 and the intermediate transport device 210 are connected in series with the intermediate transport device 10. In other words, multiple intermediate transport devices, that is, the intermediate transport devices 110 and 210, are connected in series with the intermediate transport device 10. However, one intermediate transport device may be connected in series with the intermediate transport device 10. In other words, a single intermediate transport device may be connected in series with the intermediate transport device 10.

In the exemplary embodiment above, although the intermediate transport device 110 and the intermediate transport device 210 are connected in series with the intermediate transport device 10, three or more intermediate transport devices may be connected in series with the intermediate transport device 10.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1-1)))

A medium processing system comprising:
a pre-processing device;
a first delivery device that receives a recording medium from the pre-processing device and that delivers the recording medium;
a first post-processing device that receives the recording medium delivered from the first delivery device and that performs post-processing on the recording medium;
one second delivery device or a plurality of second delivery devices that are connected in series with the first delivery device, that receive the recording medium delivered from an upstream side in a transport direction of the recording medium, and that deliver the recording medium;
a second post-processing device that receives the recording medium delivered from the one second delivery device or the plurality of second delivery devices and that performs post-processing on the recording medium;
a first controller that is provided at the first delivery device, that communicates with the first post-processing device, the pre-processing device, and the second delivery device that receives the recording medium from the first delivery device, the first controller controlling the first delivery device and the first post-processing device; and
a second controller that is provided at the one second delivery device or the plurality of second delivery devices, that, for the second delivery device that receives the recording medium from the first delivery device, communicates with the second post-processing device and controls the second delivery device and the second post-processing device that receives the recording medium from the second delivery device, and that, for another one of the plurality of second delivery devices that receives the recording medium delivered from the second delivery device, communicates with the second delivery device that delivers the recording medium and with the second post-processing device and controls the other one of the plurality of second delivery devices and the second post-processing device that receives the recording medium from the other one of the plurality of second delivery devices.
   (((1-2)))

The medium processing system according to (((1-1))), wherein when a malfunction occurs in the second post-processing device that is performing the post-processing on the recording medium and the first post-processing device is capable of performing the post-processing, the first controller causes a transport path to be changed such that the recording medium moves to the first post-processing device and causes the first post-processing device that is capable of performing the post-processing to process the recording medium.

(((1-3)))

The medium processing system according to (((1-2))), wherein when, for the post-processing by the first post-processing device, post-processing that is same as the post-processing by the second post-processing device in which the malfunction has occurred is possible, the first controller causes the post-processing that is the same to be performed on the recording medium.

(((1-4)))

The medium processing system according to (((1-2))), wherein the pre-processing device includes a pre-processing controller that controls the pre-processing device,
wherein when the post-processing by the first post-processing device differs from the post-processing by the second post-processing device in which the malfunction has occurred, the pre-processing controller causes the pre-processing device to deliver a recording medium on which the post-processing is to be performed by the first post-processing device.
   (((1-5)))

The medium processing system according to (((1-4))), wherein when the malfunction of the second post-processing device is eliminated, the first controller causes the first post-processing device to perform the post-processing on the recording medium until an entirety of the post-processing performed on the recording medium by the first post-processing device ends.

(((1-6)))

The medium processing system according to (((1-1))), wherein when a malfunction occurs in the first post-processing device that is performing the post-processing on the recording medium and the second post-processing device is capable of performing the post-processing, the first controller causes a transport path to be changed such that the recording medium moves to the second post-processing device and causes the second post-processing device that is capable of performing the post-processing to process the recording medium.

(((1-7)))

The medium processing system according to (((1-6))), wherein when, for the post-processing by the second post-processing device, post-processing that is same as the post-processing by the first post-processing device in which the malfunction has occurred is possible, the first controller causes the post-processing that is the same to be performed on the recording medium.

(((1-8)))

The medium processing system according to (((1-6))), wherein the pre-processing device includes a pre-processing controller that controls the pre-processing device,
wherein when the post-processing by the second post-processing device differs from the post-processing by the first post-processing device in which the malfunction has occurred, the pre-processing controller causes the pre-processing device to deliver a recording medium on which the post-processing is to be performed by the second post-processing device.
   (((1-9)))

The medium processing system according to (((1-8))), wherein when the malfunction of the first post-processing device is eliminated, the first controller causes the second post-processing device to perform the post-processing on the recording medium until an entirety of the post-processing performed on the recording medium by the second post-processing device ends.

(((1-10)))

The medium processing system according to (((1-1))), wherein a plurality of the second delivery devices are provided, and

wherein a plurality of the second post-processing devices are provided, and when a malfunction occurs in one of the plurality of the second post-processing devices that is performing post-processing on a recording medium and another one of the plurality of the second post-processing devices is capable of performing post-processing, the first controller causes a transport path to be changed such that a recording medium moves to the other one of the plurality of the second post-processing devices and causes the other one of the plurality of the second post-processing devices that is capable of performing the post-processing to process the recording medium.

(((1-11)))

The medium processing system according to (((1-10))), wherein when, for the post-processing by the other one of the plurality of the second post-processing devices, post-processing that is same as the post-processing by the one of the plurality of the second post-processing devices in which the malfunction has occurred is possible, the first controller causes the post-processing that is the same to be performed on the recording medium.

(((1-12)))

The medium processing system according to (((1-10))), wherein the pre-processing device includes a pre-processing controller that controls the pre-processing device, and
wherein when the post-processing by the other one of the plurality of the second post-processing devices differs from the post-processing by the one of the plurality of the second post-processing devices in which the malfunction has occurred, the pre-processing controller causes the pre-processing device to deliver a recording medium on which the post-processing is to be performed by the other one of the plurality of the second post-processing devices.
   (((1-13)))

The medium processing system according to (((1-12))), wherein when the malfunction of the one of the plurality of the second post-processing devices is eliminated, the first controller causes the other one of the plurality of the second post-processing devices to perform the post-processing on the recording medium until an entirety of the post-processing performed on the recording medium by the other one of the plurality of the second post-processing devices ends.

(((1-14)))

The medium processing system according to (((1-1))), wherein when the second post-processing device and the first post-processing device alternately perform the post-processing on the recording medium, if a malfunction occurs in the second post-processing device and the first post-processing device is capable of performing the post-processing, the first controller causes the first post-processing device to perform the post-processing on the recording medium.

(((1-15)))

The medium processing system according to (((1-1))), wherein when the second post-processing device and the first post-processing device alternately perform the post-processing on the recording medium, if a malfunction occurs in the first post-processing device and the second post-processing device is capable of performing the post-processing, the first controller causes the second post-processing device to perform the post-processing on the recording medium.

(((1-16)))

The medium processing system according to (((1-1))), wherein a plurality of the second post-processing devices are provided, and wherein when one of the plurality of the second post-processing devices and another one of the plurality of the second post-processing devices alternately perform post-processing on a recording medium, if a malfunction occurs in the one of the plurality of the second post-processing devices and the other one of the plurality of the second post-processing devices is capable of performing the post-processing, the first controller causes the other one of the plurality of the second post-processing devices to perform the post-processing on the recording medium.

(((2-1)))

A medium processing system comprising:
a pre-processing device;
a delivery device that receives a recording medium from the pre-processing device and that delivers the recording medium in a plurality of directions;
a first post-processing device that receives the recording medium delivered in a first direction from the delivery device and that performs post-processing on the recording medium;
a second post-processing device that receives the recording medium delivered in a second direction differing from the first direction from the delivery device and that performs post-processing on the recording medium; and
a controller that is provided at the delivery device, that controls the delivery device, the first post-processing device, and the second post-processing device, that communicates with the pre-processing device, and that, when a malfunction occurs in the first post-processing device that is performing the post-processing on the recording medium, causes the delivery device to deliver a recording medium in the second direction and causes the second post-processing device to perform the post-processing on the recording medium.
   (((2-2)))

The medium processing system according to (((2-1))), wherein when the post-processing by the second post-processing device is post-processing that is same as the post-processing by the first post-processing device in which the malfunction has occurred, the first controller causes the second post-processing device to continue the post-processing that is the same as the post-processing by the first post-processing device.

(((2-3)))

The medium processing system according to (((2-2))), wherein when the malfunction of the first post-processing device is eliminated, the controller causes the delivery device to deliver a recording medium in the first direction, and causes the first post-processing device to perform the post-processing on the recording medium.

(((2-4)))

The medium processing system according to (((2-1))), wherein the pre-processing device includes a pre-processing controller that controls the pre-processing device, and
wherein when the post-processing by the second post-processing device differs from the post-processing by the first post-processing device in which the malfunction has occurred, the pre-processing controller causes the pre-processing device to deliver a recording medium on which the post-processing is to be performed by the second post-processing device.
   (((2-5)))

The medium processing system according to (((2-4))), wherein when the malfunction of the first post-processing device is eliminated, the controller causes the second post-processing device to perform the post-processing on the recording medium until an entirety of the post-processing performed on the recording medium by the second post-processing device ends.

(((2-6)))

A medium processing system comprising:
a pre-processing device;
a delivery device that receives a recording medium from the pre-processing device and that delivers the recording medium in a plurality of directions;
a first post-processing device that receives the recording medium delivered in a first direction from the delivery device and that performs post-processing on the recording medium;
a second post-processing device that receives the recording medium delivered in a second direction differing from the first direction from the delivery device and that performs post-processing on the recording medium; and
a controller that is provided at the delivery device, that controls the delivery device, the first post-processing device, and the second post-processing device, that communicates with the pre-processing device, and that, when a malfunction occurs in the first post-processing device when the first post-processing device and the second post-processing device are alternately performing the post-processing on the recording medium, causes the delivery device to deliver a recording medium in the second direction and causes the second post-processing device to perform the post-processing on the recording medium.

What is claimed is:

1. A medium processing system comprising:
a pre-processing device;
a first delivery device that receives a recording medium from the pre-processing device and that delivers the recording medium;
a first post-processing device that receives the recording medium delivered from the first delivery device and that performs post-processing on the recording medium;
one second delivery device or a plurality of second delivery devices that are connected in series with the first delivery device, that receive the recording medium delivered from an upstream side in a transport direction of the recording medium, and that deliver the recording medium;
a second post-processing device that receives the recording medium delivered from the one second delivery device or the plurality of second delivery devices and that performs post-processing on the recording medium;
a first controller that is provided at the first delivery device and that communicates with the first post-processing device, the pre-processing device, and the second delivery device that receives the recording medium from the first delivery device, the first controller controlling the first delivery device and the first post-processing device; and
a second controller that is provided at the one second delivery device or the plurality of second delivery devices, that, for the second delivery device that receives the recording medium from the first delivery device, communicates with the second post-processing device and controls the second delivery device and the second post-processing device that receives the recording medium from the second delivery device, and that, for another one of the plurality of second delivery devices that receives the recording medium delivered from the second delivery device, communicates with the second delivery device that delivers the recording medium and with the second post-processing device and controls the other one of the plurality of second delivery devices and the second post-processing device that receives the recording medium from the other one of the plurality of second delivery devices.

2. A medium processing system comprising:
a pre-processing device;
a first delivery device that receives a recording medium from the pre-processing device and that delivers the recording medium in a plurality of directions;
a first post-processing device that receives the recording medium delivered in a first direction from the first delivery device and that performs post-processing on the recording medium;
a second post-processing device that receives the recording medium delivered in a second direction differing from the first direction from the first delivery device and that performs post-processing on the recording medium; and
a first controller that is provided at the first delivery device, that controls the first delivery device, the first post-processing device, and the second post-processing device, that communicates with the pre-processing device, and that, when a malfunction occurs in the second post-processing device that is performing the post-processing on the recording medium, causes the first delivery device to deliver the recording medium in the first direction and causes the first post-processing device to perform the post-processing on the recording medium.

3. The medium processing system according to claim 2, wherein when, for the post-processing by the first post-processing device, post-processing that is same as the post-processing by the second post-processing device in which the malfunction has occurred is possible, the first controller causes the post-processing that is the same to be performed on the recording medium.

4. The medium processing system according to claim 2, wherein the pre-processing device includes a pre-processing controller that controls the pre-processing device, and
wherein when the post-processing by the first post-processing device differs from the post-processing by the second post-processing device in which the malfunction has occurred, the pre-processing controller causes the pre-processing device to deliver a recording medium on which the post-processing is to be performed by the first post-processing device.

5. The medium processing system according to claim 4, wherein when the malfunction of the second post-processing device is eliminated, the first controller causes the first post-processing device to perform the post-processing on the recording medium until an entirety of the post-processing performed on the recording medium by the first post-processing device ends.

6. The medium processing system according to claim 1, wherein when a malfunction occurs in the first post-processing device that is performing the post-processing on the recording medium and the second post-processing device is capable of performing the post-processing, the first controller causes a transport path to be changed such that the recording medium moves to the second post-processing device and causes the second post-processing device that is capable of performing the post-processing to process the recording medium.

7. The medium processing system according to claim 6, wherein when, for the post-processing by the second post-processing device, post-processing that is same as the post-processing by the first post-processing device in which the malfunction has occurred is possible, the first controller causes the post-processing that is the same to be performed on the recording medium.

8. The medium processing system according to claim 6, wherein the pre-processing device includes a pre-processing controller that controls the pre-processing device, and
wherein when the post-processing by the second post-processing device differs from the post-processing by the first post-processing device in which the malfunction has occurred, the pre-processing controller causes the pre-processing device to deliver a recording medium on which the post-processing is to be performed by the second post-processing device.

9. The medium processing system according to claim 8, wherein when the malfunction of the first post-processing device is eliminated, the first controller causes the second post-processing device to perform the post-processing on the recording medium until an entirety of the post-processing performed on the recording medium by the second post-processing device ends.

10. The medium processing system according to claim 1, wherein a plurality of the second delivery devices are provided, and
wherein a plurality of the second post-processing devices are provided, and when a malfunction occurs in one of the plurality of the second post-processing devices that is performing post-processing on a recording medium and another one of the plurality of the second post-processing devices is capable of performing post-processing, the first controller causes a transport path to be changed such that a recording medium moves to the other one of the plurality of the second post-processing devices and causes the other one of the plurality of the second post-processing devices that is capable of performing the post-processing to process the recording medium.

11. The medium processing system according to claim 10, wherein when, for the post-processing by the other one of the plurality of the second post-processing devices, post-processing that is same as the post-processing by the one of the plurality of the second post-processing devices in which the malfunction has occurred is possible, the first controller causes the post-processing that is the same to be performed on the recording medium.

12. The medium processing system according to claim 10, wherein the pre-processing device includes a pre-processing controller that controls the pre-processing device, and
wherein when the post-processing by the other one of the plurality of the second post-processing devices differs from the post-processing by the one of the plurality of the second post-processing devices in which the malfunction has occurred, the pre-processing controller causes the pre-processing device to deliver a recording medium on which the post-processing is to be performed by the other one of the plurality of the second post-processing devices.

13. The medium processing system according to claim 12, wherein when the malfunction of the one of the plurality of the second post-processing devices is eliminated, the first controller causes the other one of the plurality of the second post-processing devices to perform the post-processing on the recording medium until an entirety of the post-processing performed on the recording medium by the other one of the plurality of the second post-processing devices ends.

14. The medium processing system according to claim 1, wherein when the second post-processing device and the first post-processing device alternately perform the post-processing on the recording medium, if a malfunction occurs in the second post-processing device and the first post-processing device is capable of performing the post-processing, the first controller causes the first post-processing device to perform the post-processing on the recording medium.
